(19) United States
(12) Patent Application Publication
(10) Pub. No.: US 2025/0039861 A1
(43) Pub. Date: Jan. 30, 2025

(54) TRANSMISSION PROCESSING METHOD AND APPARATUS, TERMINAL, AND NETWORK-SIDE DEVICE

(71) Applicant: VIVO MOBILE COMMUNICATION CO., LTD., Dongguan (CN)

(72) Inventors: Siqi LIU, Dongguan (CN); Jiansheng CAI, Dongguan (CN); Zichao JI, Dongguan (CN)

(73) Assignee: VIVO MOBILE COMMUNICATION CO., LTD., Dongguan (CN)

(21) Appl. No.: 18/914,261

(22) Filed: Oct. 14, 2024

Related U.S. Application Data
(63) Continuation of application No. PCT/CN2023/087815, filed on Apr. 12, 2023.

(30) Foreign Application Priority Data
Apr. 14, 2022 (CN) 202210414142.7

(51) Int. Cl. H04W 72/12; H04B 7/06; H04L 27/26; H04W 72/20; H04W 76/20

(52) U.S. Cl. CPC H04W 72/12; H04B 7/06968; H04L 27/26025; H04W 72/20; H04W 76/20

(57) ABSTRACT

A transmission processing method and apparatus, a terminal, and a network-side device are provided. The method includes: obtaining, by a terminal, control information; and performing, by the terminal, a corresponding terminal behavior based on the control information. Performing, by the terminal, the corresponding terminal behavior based on the control information includes at least one of the following: performing, based on the control information, a target transmission corresponding to the control information; performing, by the terminal based on the control information, at least a first part of one or more transmissions corresponding to the control information; or skipping or discarding, by the terminal based on the control information, at least a second part of the one or more transmissions corresponding to the control information. The control information corresponds to transmissions on at least two objects, or the control information corresponds to at least two transmissions.

### CROSS-REFERENCE TO RELATED APPLICATIONS

This application is a continuation of International Application No. PCT/CN2023/087815, filed on Apr. 12, 2023, which claims priority to Chinese Patent Application No. 202210414142.7, filed on Apr. 14, 2022. The contents of all the above-referenced applications are expressly incorporated herein by reference in their entireties.

### TECHNICAL FIELD

This application pertains to the field of communication technologies, and in particular, to a transmission processing method and apparatus, a terminal, and a network-side device.

### BACKGROUND

A New Radio (NR) system of a 5th Generation (5G) communication system supports configuring one or more Component Carriers (CCs) or cells for User Equipment (UE, also referred to as a terminal). If channel quality of some cells is poor or a channel blocking probability is high, a network may configure cross-carrier scheduling for the UE, that is, configure a control channel in other cells with better channel quality (for example, a primary cell) to schedule data of other cells (for example, a secondary cell) across carriers. A Subcarrier Spacing (SCS) of a scheduling cell may be the same as or different from that of a scheduled cell. The scheduling cell may be in self-scheduling mode, and in this case, the cell schedules only the cell itself. If cross-carrier scheduling is configured for the scheduling cell, the scheduling cell may also schedule one or more scheduled cells other than the scheduling cell itself. The scheduled cell does not have its own Physical Downlink Control Channel (PDCCH), and can only be scheduled by one scheduling cell.

The UE monitors the PDCCH to receive Downlink Control Information (DCI), and demodulates, based on an indication of the DCI, a Physical Downlink Shared CHannel (PDSCH) scheduled by a base station. The DCI may flexibly indicate resource allocation of the PDSCH, such as a cell or a BandWidth Part (BWP) in which the PDSCH is located, frequency domain resources, and time domain resources. Time domain resource allocation may indicate a slot offset, a start Orthogonal Frequency Division Multiplexing (OFDM) symbol and symbol duration, and the like of the PDSCH. The start symbol of the PDSCH cannot be earlier than a start OFDM symbol of the PDCCH.

In cross-carrier scheduling, because the start symbol of the PDSCH may be the same as that of the PDCCH, the UE needs to buffer data of the entire BWP of the scheduled cell while receiving and blindly detecting the PDCCH. In a scenario of self-scheduling or cross-carrier scheduling in which the SCS of the scheduling cell is the same as that of the scheduled cell, the UE generally needs to buffer the data of the entire BWP until demodulation of the PDCCH is completed. However, when the SCS of the scheduling cell (that is, an SCS of the PDCCH) is less than the SCS of the scheduled cell (that is, an SCS of the PDSCH), it takes the UE a much longer time to receive the PDCCH than in a scenario with same SCSs. Consequently, the UE needs to buffer more data additionally, and the base station needs to ensure that an interval between the PDCCH and the PDSCH (for example, the foregoing slot offset) is not less than a value (denoted by delta) during scheduling, so that the UE has enough time to complete related buffering and processing.

A beam of a PDCCH of the scheduling cell may be different from a beam of a PDSCH/CSI-RS of the scheduled cell. For the PDSCH, the UE requires an extra time timeDurationForQCL (denoted by Y) to perform beam switching. For the Channel State Information Reference Signal (CSI-RS), the UE requires an extra time beamSwitchTiming (denoted by X) to perform beam switching. Therefore, the base station needs to ensure that the interval between the PDCCH and the PDSCH/CSI-RS is not less than a value during scheduling, so that the UE has enough time to complete the beam switching.

The foregoing time limit for buffering or PDCCH processing or beam switching is usually related to a scheduling SCS or a scheduled SCS.

In some examples, one piece of DCI can schedule uplink (UL) or downlink (DL) data in one cell only. Therefore, a lot of DCI overheads are caused in a case of Carrier Aggregation (CA). To reduce the DCI overheads, make more resources available for UL or DL transmissions, and improve a throughput of the system, it is needed to support one piece of DCI simultaneously scheduling UL or DL transmissions in a plurality of cells. However, when one piece of DCI schedules a plurality of cells, because SCSs of the cells may be different, some scheduled cells may fail to be scheduled due to an excessively short time interval.

### SUMMARY

Implementations of this present disclosure provide a transmission processing method and apparatus, a terminal, and a network-side device.

According to a first aspect, a transmission processing method is provided and includes:
obtaining, by a terminal, control information; and
performing, by the terminal, a corresponding terminal behavior based on the control information, where
performing, by the terminal, the corresponding terminal behavior based on the control information includes at least one of the following:
performing, based on the control information, a target transmission corresponding to the control information, where the control information or the target transmission corresponding to the control information meets a scheduling restriction;
performing, by the terminal based on the control information, at least a first part of one or more transmissions corresponding to the control information; or
skipping or discarding, by the terminal based on the control information, at least a second part of the one or more transmissions corresponding to the control information, where
the control information corresponds to transmissions on at least two objects, or the control information corresponds to at least two transmissions.

According to a second aspect, a transmission processing method is provided and includes:
sending, by a network-side device, control information, where the control information or a target transmission corresponding to the control information meets a scheduling restriction, where
the control information corresponds to transmissions on at least two objects, or the control information corresponds to at least two transmissions.

According to a third aspect, a transmission processing apparatus is provided and includes:
an obtaining module, configured to obtain control information; and
a first processing module, configured to perform a corresponding terminal behavior based on the control information, where
the performing a corresponding terminal behavior based on the control information includes at least one of the following:
performing, based on the control information, a target transmission corresponding to the control information, where the control information and/or the target transmission corresponding to the control information meets a scheduling restriction;
performing, based on the control information, at least part of one or more transmissions corresponding to the control information; and
skipping or discarding, based on the control information, at least part of the one or more transmissions corresponding to the control information, where
the control information corresponds to transmissions on at least two objects, or the control information corresponds to at least two transmissions.

According to a fourth aspect, a transmission processing apparatus is provided and includes:
a sending module, configured to send control information, where the control information and/or a target transmission corresponding to the control information meets a scheduling restriction, where
the control information corresponds to transmissions on at least two objects, or the control information corresponds to at least two transmissions.

According to a fifth aspect, a terminal is provided. The terminal includes a processor and a memory. The memory stores a program or instructions capable of running on the processor. When the program or instructions are executed by the processor, the steps of the method according to the first aspect are implemented.

According to a sixth aspect, a terminal is provided and includes a processor and a communication interface. The communication interface is configured to obtain control information; and the processor is configured to perform a corresponding terminal behavior based on the control information, where
the performing, by the terminal, a corresponding terminal behavior based on the control information includes at least one of the following:
performing, based on the control information, a target transmission corresponding to the control information, where the control information and/or the target transmission corresponding to the control information meets a scheduling restriction;
performing, based on the control information, at least part of one or more transmissions corresponding to the control information; and
skipping or discarding, based on the control information, at least part of the one or more transmissions corresponding to the control information, where
the control information corresponds to transmissions on at least two objects, or the control information corresponds to at least two transmissions.

According to a seventh aspect, a network-side device is provided. The network-side device includes a processor and a memory. The memory stores a program or instructions capable of running on the processor. When the program or instructions are executed by the processor, the steps of the method according to the second aspect are implemented.

According to an eighth aspect, a network-side device is provided and includes a processor and a communication interface. The processor is configured to send control information, where the control information and/or a target transmission corresponding to the control information meets a scheduling restriction, where
the control information corresponds to transmissions on at least two objects, or the control information corresponds to at least two transmissions.

According to a ninth aspect, a communication system is provided and includes a terminal and a network-side device. The terminal may be configured to perform the steps of the transmission processing method according to the first aspect. The network-side device may be configured to perform the steps of the transmission processing method according to the second aspect.

According to a tenth aspect, a readable storage medium is provided. The readable storage medium stores a program or instructions. When the program or instructions are executed by a processor, the steps of the method according to the first aspect are implemented, or the steps of the method according to the second aspect are implemented.

According to an eleventh aspect, a chip is provided. The chip includes a processor and a communication interface. The communication interface is coupled to the processor. The processor is configured to run a program or instructions to implement the method according to the first aspect or implement the method according to the second aspect.

According to a twelfth aspect, a computer program or program product is provided. The computer program or program product is stored in a storage medium. The computer program or program product is executed by at least one processor to implement the steps of the method according to the first aspect or implement the steps of the method according to the second aspect.

In the embodiments of this present disclosure, for the control information for scheduling the at least two objects or the at least two transmissions, the terminal and the network-side device determine the scheduling restriction of the control information and/or the target transmission corresponding to the control information, to avoid scheduling failure caused by an inability of the terminal to complete control information processing, a beam adjustment, or other operations in some cells in time due to an insufficient time interval, thereby improving scheduling efficiency of the control information.

### BRIEF DESCRIPTION OF DRAWINGS

FIG. 1 is a block diagram of a wireless communication system according to an implementation of this present disclosure;

FIG. 2 is a first schematic diagram of steps of a transmission processing method according to an implementation of this present disclosure;

FIG. 3 is a second schematic diagram of steps of a transmission processing method according to an implementation of this present disclosure;

FIG. 4 is a first schematic diagram of a structure of a transmission processing apparatus according to an implementation of this present disclosure;

FIG. 5 is a second schematic diagram of a structure of a transmission processing apparatus according to an implementation of this present disclosure;

FIG. 6 is a schematic diagram of a structure of a communication device according to an implementation of this present disclosure;

FIG. 7 is a schematic diagram of a structure of a terminal according to an implementation of this present disclosure; and

FIG. 8 is a schematic diagram of a structure of a network-side device according to an implementation of this present disclosure.

### DETAILED DESCRIPTION

The following clearly describes the technical solutions in the implementations of this present disclosure with reference to the accompanying drawings in the implementations of this present disclosure. Apparently, the described implementations are only some rather than all of the implementations of this present disclosure. All other implementations obtained by a person of ordinary skill in the art based on the implementations of this present disclosure shall fall within the protection scope of this present disclosure.

The terms “first”, “second”, and the like in this specification and claims of this present disclosure are used to distinguish between similar objects instead of describing a specific order or sequence. It should be understood that the terms used in this way are interchangeable in appropriate circumstances, so that the implementations of this present disclosure can be implemented in other orders than the order illustrated or described herein. In addition, objects distinguished by “first” and “second” usually fall within one class, and a quantity of objects is not limited. For example, there may be one or more objects. In addition, the term “and/or” in the specification and claims indicates at least one of connected objects, and the character “/” generally represents an “or” relationship between associated objects.

It should be noted that technologies described in the implementations of this present disclosure are not limited to a Long Term Evolution (LTE)/LTE-Advanced (LTE-A) system, and can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the implementations of this present disclosure are usually used interchangeably. The described technologies may be used for the foregoing systems and radio technologies, and may also be used for other systems and radio technologies. However, in the following descriptions, the New Radio (NR) system is described for an illustrative purpose, and NR terms are used in most of the following descriptions. These technologies may also be applied to other applications than an NR system application, for example, a 6th Generation (6G) communication system.

FIG. 1 is a block diagram of a wireless communication system to which an implementation of this present disclosure may be applied. The wireless communication system includes a terminal 11 and a network-side device 12. The terminal 11 may be a terminal-side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR) or Virtual Reality (VR) device, a robot, a wearable device, Vehicle User Equipment (VUE), Pedestrian User Equipment (PUE), a smart home (a home device having a wireless communication function, such as a refrigerator, a television, a washing machine, or furniture), a game console, a Personal Computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal 11 is not limited in the implementations of this present disclosure. The network-side device 12 may include an access network device or a core network device. The access network device may also be referred to as a radio access network device, a Radio Access Network (RAN), a radio access network function, or a radio access network element. The access network device may include a base station, a Wireless Local Area Network (WLAN) access point, a Wireless Fidelity (Wi-Fi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. As long as the same technical effect is achieved, the base station is not limited to specific technical terms. It should be noted that in the implementations of this present disclosure, only a base station in an NR system is used as an example for description, but a specific type of the base station is not limited.

A transmission processing method and apparatus, a terminal, and a network-side device provided in implementations of this present disclosure are hereinafter described in detail by using some implementations and application scenarios thereof with reference to the accompanying drawings.

It should be noted that the transmission processing method provided in the implementations of this present disclosure may be a transmission processing method for UE, a transmission processing method for a serving cell, a transmission processing method for a scheduling cell, a transmission processing method for at least two cells scheduled by a piece of DCI or a PDCCH, a transmission processing method for at least one scheduled cell, or a transmission processing method for a combination of {scheduling cell and at least one scheduled cell}. This is not specifically limited herein.

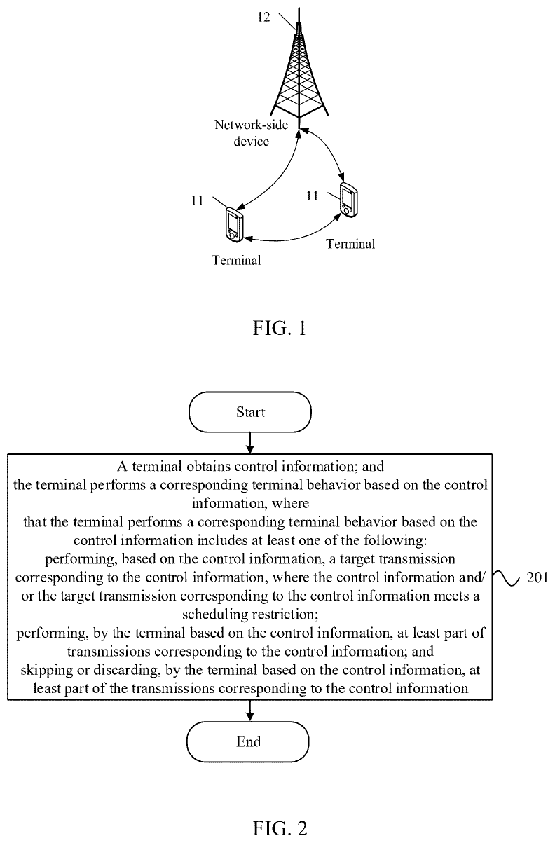

As shown in FIG. 2, an implementation of this present disclosure provides a transmission processing method, including the following steps.

Step 201: A terminal obtains control information.

Step 202: The terminal performs a corresponding terminal behavior based on the control information, where:
that the terminal performs a corresponding terminal behavior based on the control information includes at least one of the following:
performing, based on the control information, a target transmission corresponding to the control information, where the control information and/or the target transmission corresponding to the control information meets a scheduling restriction;
performing, by the terminal based on the control information, at least part of one or more transmissions corresponding to the control information; or
skipping or discarding, by the terminal based on the control information, at least part of the one or more transmissions corresponding to the control information, where
the control information corresponds to transmissions on at least two objects, or the control information corresponds to at least two transmissions.

It should be noted that in a case of performing, based on the control information, the target transmission corresponding to the control information, it may be understood that the terminal expects the control information and/or the target transmission corresponding to the control information to meet the scheduling restriction and/or that the terminal does not expect the control information and/or the target transmission corresponding to the control information not to meet the scheduling restriction.

It should be noted that the foregoing objects may be interpreted as a cell, a bandwidth part BWP, a carrier, and the like, and are not specifically limited herein. That the control information corresponds to transmissions on at least two objects may be interpreted as: the control information indicates or schedules or activates or deactivates the transmissions on the at least two objects. That the control information corresponds to at least two transmissions may be interpreted as: the control information indicates or schedules or activates or deactivates the at least two transmissions.

For example, the control information is DCI or a PDCCH.

In some implementations, that the terminal performs, based on the received control information, at least part of one or more transmissions corresponding to the control information includes:
the terminal performs, based on the received control information, a transmission that meets the scheduling restriction in the transmissions corresponding to the control information.

In some implementations, that the terminal skips or discards, based on the received control information, at least part of the one or more transmissions corresponding to the control information includes:
the terminal skips or discards, based on the received control information, a transmission that does not meet the scheduling restriction in the transmissions corresponding to the control information.

Further, in a case that the UE skips or discards at least part of the one or more transmissions corresponding to the control information, the method further includes:
the UE feeds back indication information to a network-side device, where the indication information includes at least one of the following:
a NACK; or
related information of a discarded transmission, such as a corresponding object Identity (ID) and a reason for being discarded.

In at least one implementation of this present disclosure, the target transmission includes at least one of the following items (a)-(j):

Item (a): At least part of one or more transmissions on at least one of the at least two objects corresponding to the control information.

For example, the at least part of the one or more transmissions on the at least one of the at least two objects corresponding to the control information are: the transmissions on all the objects corresponding to the control information.

For example, the at least part of the one or more transmissions on the at least one of the at least two objects corresponding to the control information are: a transmission with an earliest or latest start position in the transmissions on all the objects corresponding to the control information.

For example, the at least part of the one or more transmissions on the at least one of the at least two objects corresponding to the control information are: a transmission with an earliest or latest end position in the transmissions on all the objects corresponding to the control information.

For example, the at least part of the one or more transmissions on the at least one of the at least two objects corresponding to the control information are: a transmission on a primary cell or a special cell or a specific cell or an object including a characteristic resource or transmission (for example, with a largest or smallest SCS).

Item (b): At least one of the at least two transmissions corresponding to the control information.

For example, the at least one of the at least two transmissions corresponding to the control information is: all the transmissions corresponding to the control information.

For example, the at least one of the at least two transmissions corresponding to the control information is: a transmission with an earliest or latest start position in all the transmissions corresponding to the control information.

For example, the at least one of the at least two transmissions corresponding to the control information is: a transmission with an earliest or latest end position in all the transmissions corresponding to the control information.

For example, the at least one of the at least two transmissions corresponding to the control information is: a transmission with a largest or smallest SCS.

Item (c): At least part of one or more transmissions on a first object, where the first object is an object with a subcarrier spacing SCS less than or equal to a first reference SCS in the at least two objects corresponding to the control information, where
the transmission on the first object may be understood as a transmission indicated or scheduled or activated or deactivated by the control information on the first object.

For example, the at least part of the one or more transmissions on the first object include: all the transmissions on the first object.

For example, the at least part of the one or more transmissions on the first object include: a transmission with an earliest start position in all the transmissions on the first object.

For example, the at least part of the one or more transmissions on the first object include: a transmission with a latest start position in all the transmissions on the first object.

For example, the at least part of the one or more transmissions on the first object include: a transmission with an earliest end position in all the transmissions on the first object.

For example, the at least part of the one or more transmissions on the first object include: a transmission with a latest end position in all the transmissions on the first object.

Item (d): A first transmission, where the first transmission is at least part of one or more transmissions with SCSs less than or equal to the first reference SCS in the at least two transmissions corresponding to the control information.

For example, the first transmission is: all the transmissions with SCSs less than or equal to the first reference SCS in the at least two transmissions corresponding to the control information.

For example, the first transmission is: a transmission with an SCS less than or equal to the first reference SCS and with an earliest start position in the at least two transmissions corresponding to the control information.

For example, the first transmission is: a transmission with an SCS less than or equal to the first reference SCS and with a latest start position in the at least two transmissions corresponding to the control information.

For example, the first transmission is: a transmission with an SCS less than or equal to the first reference SCS and with an earliest end position in the at least two transmissions corresponding to the control information.

For example, the first transmission is: a transmission with an SCS less than or equal to the first reference SCS and with a latest end position in the at least two transmissions corresponding to the control information.

Item (e): At least part of one or more transmissions on a second object, where the second object is an object with a subcarrier spacing SCS greater than or equal to a second reference SCS in the at least two objects corresponding to the control information, where the transmission on the second object may be understood as a transmission indicated or scheduled or activated or deactivated by the control information on the second object.

For example, the at least part of the one or more transmissions on the second object is: all the transmissions on the second object.

For example, the at least part of the one or more transmissions on the second object is: a transmission with an earliest start position in all the transmissions on the second object.

For example, the at least part of the one or more transmissions on the second object is: a transmission with a latest start position in all the transmissions on the second object.

For example, the at least part of the one or more transmissions on the second object is: a transmission with an earliest end position in all the transmissions on the second object.

For example, the at least part of the one or more transmissions on the second object is: a transmission with a latest end position in all the transmissions on the second object.

Item (f): A second transmission, where the second transmission is at least part of one or more transmissions with SCSs greater than or equal to the second reference SCS in the at least two transmissions corresponding to the control information.

For example, the second transmission is: all the transmissions with SCSs greater than or equal to the second reference SCS in the at least two transmissions corresponding to the control information.

For example, the second transmission is: a transmission with an SCS greater than or equal to the second reference SCS and with an earliest start position in the at least two transmissions corresponding to the control information.

For example, the second transmission is: a transmission with an SCS greater than or equal to the second reference SCS and with a latest start position in the at least two transmissions corresponding to the control information.

For example, the second transmission is: a transmission with an SCS greater than or equal to the second reference SCS and with an earliest end position in the at least two transmissions corresponding to the control information.

For example, the second transmission is: a transmission with an SCS greater than or equal to the second reference SCS and with a latest end position in the at least two transmissions corresponding to the control information.

Item (g): At least part of one or more transmissions on a third object, where the third object includes at least one of an object not configured with a transmission configuration indicator TCI or multiple beams or a Quasi-Co-Location (QCL) source, an object without an activated TCI or multiple activated beams or an activated QCL source, an object on which a TCI or multiple beams or a QCL source is activated but does not take effect, an object within a frequency range FR1, and an object not higher than a first preset frequency domain position.

Item (h): A third transmission, where the third transmission includes at least part of: a transmission not configured with a transmission configuration indicator TCI or multiple beams or a QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position.

Item (i): At least part of one or more transmissions on a fourth object, where the fourth object includes at least one of an object configured with a TCI or multiple beams or a QCL source, an object with an activated TCI or multiple activated beams or an activated QCL source, an object on which a TCI or multiple beams or a QCL source is activated and takes effect, an object within a frequency range FR2, and an object not lower than a second preset frequency domain position.

Item (j): A fourth transmission, where the fourth transmission includes at least part of: a transmission configured with a TCI or multiple beams or a QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

For example, the first reference SCS and the second reference SCS may be SCSs of the control information or preset SCSs; and the first reference SCS and the second reference SCS may be a same SCS or different SCSs.

It should be noted that the “transmission” mentioned in this implementation of this present disclosure may be at least one of a sounding reference signal SRS, a demodulation reference signal DMRS, a channel state information reference signal CSI-RS, and a physical downlink shared channel PDSCH; and the transmission may also be interpreted as a transmission resource, that is, a resource that may be used for a transmission but is not actually used for a transmission, or a resource actually used for a transmission.

In some implementations of this present disclosure, the meeting a scheduling restriction includes at least one of the following:
an interval between a first position (that is, a position of the control information) corresponding to the control information and a second position (that is, a position of the target transmission) corresponding to the target transmission is greater than or equal to first duration, where the first duration may be referred to as T1;
the second position corresponding to the target transmission is not earlier than a first target position, where the first target position may be referred to as a T2 position; or
the first position corresponding to the control information is not later than a second target position, where the second target position may be referred to as a T3 position.

In some implementations of this present disclosure, the not meeting a scheduling restriction includes at least one of the following:
an interval between a first position corresponding to the control information and a second position corresponding to the target transmission is less than or equal to first duration;
the second position corresponding to the target transmission is equal to or earlier than a first target position; or
the first position corresponding to the control information is equal to or later than a second target position.

The first target position is related to the first position and the first duration; and/or the second target position is related to the second position and the first duration.

In some implementations, the first target position is:
a time position after the first duration from the first position;
or
an available time position after the first duration from the first position.

In me implementations, the second target position is:
a time position that is before the second position and is the first duration away from the second position;
or
an available time position that is before the second position and is the first duration away from the second position.

For example, the available time position is a nearest available time position, or a nearest and latest available time position, or a nearest and earliest available time position, or a nearest available time position earlier than a point, or a latest available time position earlier than a point.

It should be noted that the available time position may also be referred to as a quantized time position. A quantized time position of a position may be understood as a position corresponding to a symbol and/or span and/or slot and/or monitoring occasion and/or subframe and/or frame and/or period nearest (for example, before a time point and nearest, or after a time point and nearest) to the position.

In me implementations, the method further includes at least one of the following:
the terminal determines the QCL source or a beam switching time in a corresponding manner based on whether an interval between a first position corresponding to the control information and a second position corresponding to the target transmission is greater than or equal to first duration; for example, determines the QCL source or the beam switching time in a first manner when the interval between the first position and the second position is greater than or equal to the first duration; for another example, determines the QCL source or the beam switching time in a second manner when the interval between the first position and the second position is less than or equal to the first duration;
the terminal determines the QCL source or the beam switching time in a corresponding manner based on whether the second position is not earlier than a first target position; for example, determines the QCL source or the beam switching time in a third manner when the second position is earlier than the first target position; for another example, determines the QCL source or the beam switching time in a fourth manner when the second position is not earlier than the first target position; or
the terminal determines the QCL source or the beam switching time in a corresponding manner based on whether the first position is not later than a second target position; for example, determines the QCL source or the beam switching time in a fifth manner when the first position is later than the second target position; for another example, determines the QCL source or the beam switching time in a sixth manner when the first position is not later than the second target position.

In me implementations, the first duration is related to second information, and the second information includes at least one of the following:
a scheduling offset;
a scheduling interval;
a second time required for beam switching; and
a third time required for QCL.

The first duration is a time interval between a position corresponding to a nearest symbol and/or span and/or slot and/or monitoring occasion and/or subframe and/or frame and/or period after the second information is met and the position (that is, the first position) of the control information, and may also be understood as a time interval between the position corresponding to the symbol and/or span and/or slot and/or monitoring occasion and/or subframe and/or frame and/or period after the second information is rounded and the position of the control information.

For example, the first duration is at least one item of the foregoing second information, or a weighted sum of at least two items, or a largest or smallest value of at least two items, or a quantized time of at least one item of the second information, or a quantized time of a weighted sum of at least two items, or a quantized time of a largest value or a smallest value of at least two items, which is not specifically limited herein.

It should be noted that the first position is the position of the control information, and the position of the control information may be understood as: a start position or an end position of a symbol and/or span and/or slot and/or monitoring occasion and/or subframe and/or frame and/or period in which the control information is located or which corresponds to the control information; and for example, the position of the control information is an end position of the PDCCH.

The second position is a position of the target transmission, where the position of the target transmission may be understood as: a start position or an end position of a symbol and/or slot and/or burst and/or set and/or subframe and/or frame and/or period in which the target transmission is located or which corresponds to the target transmission, or a position of a symbol; and for example, the position of the target transmission is a position of a first symbol of the PDSCH.

In at least one implementation of this present disclosure, the scheduling restriction is related to first information, and the first information includes at least one of the following:
an SCS of the control information;
a time domain start point of the control information;
a time domain end point of the control information;
a time unit in which the control information is located;
time domain duration of the control information;
the first position corresponding to the control information, that is, the position of the control information;
a processing time of the control information, for example, a maximum processing time, a minimum processing time, or a preset processing time;
a processing or preparation time for transmission;
a buffering time, for example, a maximum buffering time, a minimum buffering time, or a preset buffering time;
a target SCS;
a second time required for beam switching;
a third time required for QCL;
a scheduling interval;
a scheduling offset;
time domain duration of the target transmission;
a time domain start point of the target transmission;
a time domain end point of the target transmission;
the second position corresponding to the target transmission, that is, the position of the target transmission;
time domain duration of a reference transmission;
a third position corresponding to the reference transmission, that is, a position of the reference transmission; and
a frequency domain position corresponding to the control information.

In at least one implementation of this present disclosure, the reference transmission includes at least one of the following items (a)-(j):

Item (a) At least part of one or more transmissions on at least one of the at least two objects corresponding to the control information.

For example, the at least part of the one or more transmissions on the at least one of the at least two objects corresponding to the control information are: the transmissions on all the objects corresponding to the control information.

For example, the at least part of the one or more transmissions on the at least one of the at least two objects corresponding to the control information are: a transmission with an earliest or latest start position in the transmissions on all the objects corresponding to the control information.

For example, the at least part of the one or more transmissions on the at least one of the at least two objects corresponding to the control information are: a transmission with an earliest or latest end position in the transmissions on all the objects corresponding to the control information.

For example, the at least part of the one or more transmissions on the at least one of the at least two objects corresponding to the control information are: a transmission on a primary cell or a special cell or a specific cell or an object including a characteristic resource or transmission (for example, with a largest or smallest SCS).

Item (b) At least one of the at least two transmissions corresponding to the control information.

For example, the at least one of the at least two transmissions corresponding to the control information is: all the transmissions corresponding to the control information.

For example, the at least one of the at least two transmissions corresponding to the control information is: a transmission with an earliest or latest start position in all the transmissions corresponding to the control information.

For example, the at least one of the at least two transmissions corresponding to the control information is: a transmission with an earliest or latest end position in all the transmissions corresponding to the control information.

For example, the at least one of the at least two transmissions corresponding to the control information is: a transmission with a largest or smallest SCS.

Item (c) At least part of one or more transmissions on a first object, where the first object is an object with a subcarrier spacing SCS less than or equal to the first reference SCS in
the at least two objects corresponding to the control information, where the transmission on the first object may be understood as a transmission indicated or scheduled or activated or deactivated by the control information on the first object.

For example, the at least part of the one or more transmissions on the first object include:
all the transmissions on the first object.

For example, the at least part of the one or more transmissions on the first object include: a transmission with an earliest start position in all the transmissions on the first object.

For example, the at least part of the one or more transmissions on the first object include: a transmission with a latest start position in all the transmissions on the first object.

For example, the at least part of the one or more transmissions on the first object include: a transmission with an earliest end position in all the transmissions on the first object.

For example, the at least part of the one or more transmissions on the first object include: a transmission with a latest end position in all the transmissions on the first object.

Item (d) A first transmission, where the first transmission is at least part of one or more transmissions with SCSs less than or equal to the first reference SCS in the at least two transmissions corresponding to the control information.

For example, the first transmission is: all the transmissions with SCSs less than or equal to the first reference SCS in the at least two transmissions corresponding to the control information.

For example, the first transmission is: a transmission with an SCS less than or equal to the first reference SCS and with an earliest start position in the at least two transmissions corresponding to the control information.

For example, the first transmission is: a transmission with an SCS less than or equal to the first reference SCS and with a latest start position in the at least two transmissions corresponding to the control information.

For example, the first transmission is: a transmission with an SCS less than or equal to the first reference SCS and with an earliest end position in the at least two transmissions corresponding to the control information.

For example, the first transmission is: a transmission with an SCS less than or equal to the first reference SCS and with a latest end position in the at least two transmissions corresponding to the control information.

Item (e) At least part of one or more transmissions on a second object, where the second object is an object with a subcarrier spacing SCS greater than or equal to the second reference SCS in the at least two objects corresponding to the control information, where
the transmission on the second object may be understood as a transmission indicated or scheduled or activated or deactivated by the control information on the second object.

For example, the at least part of the one or more transmissions on the second object is: all the transmissions on the second object.

For example, the at least part of the one or more transmissions on the second object is: a transmission with an earliest start position in all the transmissions on the second object.

For example, the at least part of the one or more transmissions on the second object is: a transmission with a latest start position in all the transmissions on the second object.

For example, the at least part of the one or more transmissions on the second object is: a transmission with an earliest end position in all the transmissions on the second object.

For example, the at least part of the one or more transmissions on the second object is: a transmission with a latest end position in all the transmissions on the second object.

Item (f) A second transmission, where the second transmission is at least part of one or more transmissions with SCSs greater than or equal to the second reference SCS in the at least two transmissions corresponding to the control information.

For example, the second transmission is: all the transmissions with SCSs greater than or equal to the second reference SCS in the at least two transmissions corresponding to the control information.

For example, the second transmission is: a transmission with an SCS greater than or equal to the second reference SCS and with an earliest start position in the at least two transmissions corresponding to the control information.

For example, the second transmission is: a transmission with an SCS greater than or equal to the second reference SCS and with a latest start position in the at least two transmissions corresponding to the control information.

For example, the second transmission is: a transmission with an SCS greater than or equal to the second reference SCS and with an earliest end position in the at least two transmissions corresponding to the control information.

For example, the second transmission is: a transmission with an SCS greater than or equal to the second reference SCS and with a latest end position in the at least two transmissions corresponding to the control information.

Item (g) At least part of one or more transmissions on a third object, where the third object includes at least one of an object not configured with a transmission configuration indicator TCI or multiple beams or a QCL source, an object without an activated TCI or multiple activated beams or an activated QCL source, an object on which a TCI or multiple beams or a QCL source is activated but does not take effect, an object within the frequency range FR1, and an object not higher than the first preset frequency domain position.

Item (h) A third transmission, where the third transmission includes at least part of: a transmission not configured with a transmission configuration indicator TCI or multiple beams or a QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position.

Item (i) At least part of one or more transmissions on a fourth object, where the fourth object includes at least one of an object configured with a TCI or multiple beams or a QCL source, an object with an activated TCI or multiple activated beams or an activated QCL source, an object on which a TCI or multiple beams or a QCL source is activated and takes effect, an object within the frequency range FR2, and an object not lower than the second preset frequency domain position.

Item (j) A fourth transmission, where the fourth transmission includes at least part of: a transmission configured with a TCI or multiple beams or a QCL source, a transmission an activated TCI or multiple activated beams or an activated QCL source, a transmission in which a TCI or multiple beams or a QCL source is activated and takes effect, a transmission within the frequency range FR2, and a transmission not lower than the second preset frequency domain position.

A definition range of the reference transmission is the same as a definition range of the target transmission, but the reference transmission and the target transmission may correspond to a same item or different items within the definition range. For example, the target transmission is interpreted as all transmissions scheduled by the PDCCH, while the reference transmission is interpreted as an earliest transmission in all the transmissions scheduled by the PDCCH. Details are not exhaustively described herein.

For example, at least one of the first duration, the first target position, and the second target position is related to the first information. For example, at least one of the scheduling offset Delta or the second time required for beam switching or the scheduling interval K is determined based on the SCS of the control information and/or the target SCS. For example, the quantized time or quantized position is quantized based on the target SCS, that is, quantized to a nearest symbol and/or span and/or slot and/or monitoring occasion and/or subframe and/or frame and/or period calculated based on the target SCS.

In at least one implementation of this present disclosure, the target SCS includes at least one of the following entries (1)-(5):

(1) A first specific SCS, where the first specific SCS is at least part of one or more SCSs of the at least two objects corresponding to the control information or at least part of one or more SCSs of the at least two transmissions corresponding to the control information.

For example, the at least part of the one or more SCSs may be understood as: a largest SCS or a smallest SCS or a preset SCS.

For example, a PDCCH SCS is 15 kHz, and SCSs of transmissions in four scheduled cells 1, 2, 3, and 4 are 15 kHz, 15 kHz, 30 kHz, and 60 kHz respectively; and if the target SCS is a largest one of SCSs of transmissions scheduled by the PDCCH, the target SCS is 60 KHz.

(2) A second specific SCS, where the second specific SCS is at least part of one or more SCSs of the first object or at least part of one or more SCSs of the first transmission.

For example, the at least part of the one or more SCSs may be understood as: a largest SCS or a smallest SCS or a preset SCS.

For example, a PDCCH SCS is 15 kHz, and SCSs of transmissions in four scheduled cells 1, 2, 3, and 4 are 15 kHz, 15 kHz, 30 kHz, and 60 kHz respectively; assuming that the first reference SCS and the second reference SCS are PDCCH SCSs, the first transmission is transmissions in cells 1 and 2, and the second transmission is transmissions in cells 3 and 4; and if the target SCS is a largest one of the SCSs of the first transmission, the target SCS is 15 kHz.

(3) A third specific SCS, where the third specific SCS is at least part of one or more SCSs of the second object or at least part of one or more SCSs of the second transmission.

For example, the at least part of the one or more SCSs may be understood as: a largest SCS or a smallest SCS or a preset SCS.

For example, a PDCCH SCS is 15 kHz, and SCSs of transmissions in four scheduled cells 1, 2, 3, and 4 are 15 kHz, 15 kHz, 30 kHz, and 60 kHz respectively; assuming that the first reference SCS and the second reference SCS are PDCCH SCSs, the first transmission is transmissions in cells 1 and 2, and the second transmission is transmissions in cells 3 and 4; and if the target SCS is a largest one of the SCSs of the first transmission, the target SCS is 15 kHz.

(4) A fourth specific SCS, where the fourth specific SCS is at least part of one or more SCSs of the third object or at least part of one or more SCSs of the third transmission.

For example, the at least part of the one or more SCSs may be understood as: a largest SCS or a smallest SCS or a preset SCS.

(5) A fifth specific SCS, where the fifth specific SCS is at least part of one or more SCSs of the fourth object or at least part of one or more SCSs of the fourth transmission.

For example, the at least part of the one or more SCSs may be understood as: a largest SCS or a smallest SCS or a preset SCS.

In at least one implementation of this present disclosure, the second time required for beam switching includes the beam switching time, or a beam switching time and a beam switching extra time;
and/or
the third time required for QCL includes a time required for QCL, or a time required for QCL and an extra time required for QCL.

For example, the beam switching time beamSwitchTiming may be referred to as X:
the beam switching time is a longest and/or shortest and/or preset beam switching time among beam switching times corresponding to an object or a transmission (band or band combination) scheduled by the control information;
the beam switching time is a longest and/or shortest and/or preset beam switching time among beam switching times corresponding to the first cell and/or the first transmission (band or band combination); and
the beam switching time is a longest and/or shortest and/or preset beam switching time among beam switching times corresponding to the second cell and/or the second transmission (band or band combination).

For example, the beam switching extra time beamSwitchTiming may be referred to as d1:
the beam switching extra time is a longest and/or shortest and/or preset beam switching extra time among beam switching extra times corresponding to a cell and/or a transmission (band or band combination) scheduled by the control information;
the beam switching extra time is a longest and/or shortest and/or preset beam switching extra time among beam switching extra times corresponding to the first cell or the first transmission (band or band combination); and the beam switching extra time is a longest and/or shortest and/or preset beam switching extra time among beam switching extra times corresponding to the second cell and/or the second transmission (band or band combination).

For example, the time required for QCL timeDurationForQCL may be referred to as Y:
the time required for QCL is a longest and/or shortest and/or preset time required for QCL among times required for QCL corresponding to a cell and/or a transmission (band or band combination) scheduled by the control information;
the time required for QCL is a longest and/or shortest and/or preset time required for QCL among times required for QCL corresponding to the first cell and/or first transmission (band or band combination); and
the time required for QCL is a longest and/or shortest and/or preset time required for QCL among times required for QCL corresponding to the second cell and/or second transmission (band or band combination).

For example, the extra time required for QCL timeDurationForQCL may be referred to as d2:
the extra time required for QCL is a longest and/or shortest and/or preset extra time required for QCL among extra times required for QCL corresponding to a cell and/or a transmission (band or band combination) scheduled by the control information;
the extra time required for QCL is a longest and/or shortest and/or preset extra time required for QCL among extra times required for QCL corresponding to the first cell and/or first transmission (band or band combination); and
the extra time required for QCL is a longest and/or shortest and/or preset extra time required for QCL among extra times required for QCL corresponding to the second cell and/or second transmission (band or band combination).

In still another optional implementation of this present disclosure, the scheduling interval K includes at least one of the following:
a first specific scheduling interval for cross-slot scheduling, for example, a longest or shortest or preset scheduling interval for cross-slot scheduling;
a second specific scheduling interval in scheduling intervals corresponding to the control information, for example, a longest and/or shortest and/or preset scheduling interval in scheduling intervals corresponding to a cell and/or a transmission (band or band combination) scheduled by the control information;
a third specific scheduling interval in scheduling intervals corresponding to the first object, for example, a longest and/or shortest and/or preset scheduling interval in scheduling intervals corresponding to the first cell (band or band combination);
a fourth specific scheduling interval in scheduling intervals corresponding to the first transmission, for example, a longest and/or shortest and/or preset scheduling interval in the scheduling intervals corresponding to the first transmission (band or band combination);
a fifth specific scheduling interval in scheduling intervals corresponding to the second object, for example, a longest and/or shortest and/or preset scheduling interval in scheduling intervals corresponding to the second cell (band or band combination); and
a sixth specific scheduling interval in scheduling intervals corresponding to the second transmission, for example, a longest and/or shortest and/or preset scheduling interval in the scheduling intervals corresponding to the second transmission (band or band combination).

For example, the scheduling interval may be an interval for scheduling a PDSCH, an interval for scheduling a PUSCH or an interval for scheduling an RS (for example, an interval for scheduling an SRS or an interval for scheduling a CSI-RS).

In still another optional implementation of this present disclosure, the scheduling offset delta includes at least one of the following:
a first specific scheduling offset, for example, a largest or smallest or preset scheduling offset;
a second specific scheduling offset in scheduling offsets corresponding to the control information, for example, a longest and/or shortest and/or preset scheduling offset in scheduling offsets corresponding to a cell and/or a transmission (band or band combination) scheduled by the control information;
a third specific scheduling offset in scheduling offsets corresponding to the first object, for example, a largest and/or smallest and/or preset scheduling offset in scheduling offsets corresponding to the first cell (band or band combination);
a fourth specific scheduling offset in scheduling offsets corresponding to the first transmission, for example, a largest and/or smallest and/or preset scheduling offset in the scheduling offsets corresponding to the first transmission (band or band combination);
a fifth specific scheduling offset in scheduling offsets corresponding to the second object, for example, a largest and/or smallest and/or preset scheduling offset in scheduling offsets corresponding to the second cell (band or band combination); and
a sixth specific scheduling offset in scheduling offsets corresponding to the second transmission, for example, a largest and/or smallest and/or preset scheduling offset in the scheduling offsets corresponding to the second transmission (band or band combination).

In an optional implementation, the scheduling restriction is at least related to the first specific SCS in a case that the target transmission is the at least part of the one or more transmissions on the at least one object corresponding to the control information or the at least one transmission corresponding to the control information; that is, all cells and/or transmissions scheduled by the PDCCH need to meet a same scheduling restriction.

For example, if the scheduling restriction includes quantization, the quantization is related to the first specific SCS.

For example, if the scheduling restriction includes X and/or Y, the X and/or Y is related to the first specific SCS.

In an optional implementation, the scheduling restriction is at least related to the second specific SCS in a case that the target transmission is the at least part of the one or more transmissions on the first object or in a case that the target transmission is the first transmission; that is, a cell and/or a transmission in which an SCS scheduled by the PDCCH is less than or equal to the PDCCH SCS need/needs to meet a same scheduling restriction (the restriction may be related to a largest SCS and/or a smallest SCS of the cell and/or transmission less than or equal to the PDCCH SCS); and further, a cell and/or a transmission in which an SCS scheduled by the PDCCH is greater than or equal to the PDCCH SCS meets another scheduling restriction (the restriction may be related to a largest SCS and/or a smallest SCS of the cell and/or transmission greater than or equal to the PDCCH SCS).

For example, if the scheduling restriction includes quantization, the quantization is related to the second specific SCS.

For example, if the scheduling restriction includes X and/or Y, the X and/or Y is related to the second specific SCS.

In an optional implementation, the scheduling restriction is at least related to the third specific SCS in a case that the target transmission is the at least part of the one or more transmissions on the second object or in a case that the target transmission is the second transmission; that is, a cell and/or a transmission in which an SCS scheduled by the PDCCH is greater than or equal to the PDCCH SCS need/needs to meet a same scheduling restriction (the restriction may be related to a largest SCS and/or a smallest SCS of the cell and/or transmission greater than or equal to the PDCCH SCS); and further, a cell and/or a transmission in which an SCS scheduled by the PDCCH is less than or equal to the PDCCH SCS need/needs to meet another scheduling restriction (the restriction may be related to a largest SCS and/or a smallest SCS of the cell and/or transmission less than or equal to the PDCCH SCS).

For example, if the scheduling restriction includes quantization, the quantization is related to the third specific SCS.

For example, if the scheduling restriction includes X and/or Y, the X and/or Y is related to the third specific SCS.

In an optional implementation, the scheduling restriction is at least related to at least one of the first specific SCS, the fourth specific SCS, the fifth specific SCS, and the frequency domain position in a case that the target transmission is the at least part of the one or more transmissions on the third object or in a case that the target transmission is the third transmission.

In an optional implementation, the scheduling restriction is at least related to at least one of the first specific SCS, the fourth specific SCS, the fifth specific SCS, and the frequency domain position in a case that the target transmission is the at least part of the one or more transmissions on the fourth object or in a case that the target transmission is the fourth transmission.

For example, if the scheduling restriction includes X and/or Y, the X and/or Y is related to at least one of the first specific SCS, the fourth specific SCS, the fifth specific SCS, and the frequency domain position.

Further, in at least one implementation of this present disclosure, in a case that the control information includes or is associated with or indicates or corresponds to one piece of target information, the target transmission is the at least part of the one or more transmissions on the at least one object corresponding to the control information (for example, the target transmission is at least part of the one or more transmissions on all the objects corresponding to the control information) or the at least one transmission corresponding to the control information (for example, all the transmissions corresponding to the control information), and the scheduling restriction is at least related to the first specific SCS. In other words, when the control information indicates only a unified piece of target information, all the cells and/or transmissions scheduled by the control information need to meet a same restriction.

For example, the target information may be offset information between the transmission and the control information, such as a PDSCH offset K0 and a PUSCH offset K2, such as time domain resource allocation information, such as a CSI-RS request, such as CSI-RS resource allocation information, such as a CSI-RS offset, such as an SRS request, such as SRS resource allocation information, such as an SRS offset, such as a TCI indication. Details are not exhaustively illustrated herein.

Further, in at least one implementation of this present disclosure, in a case that the control information includes or is associated with or indicates or corresponds to at least two pieces of target information, the target transmission is the at least part of the one or more transmissions on the first object, or the target transmission is the first transmission, and the scheduling restriction is at least related to the second specific SCS, where
the at least two pieces of target information include target information of the first object or the first transmission and target information of the second object or the second transmission; or
the at least two pieces of target information include target information of each object or each transmission corresponding to the control information.

Alternatively, in a case that the control information includes or is associated with or indicates or corresponds to at least two pieces of target information, the target transmission is the at least part of the one or more transmissions on the second object, or the target transmission is the second transmission, and the scheduling restriction is at least related to the third specific SCS, where
the at least two pieces of target information include target information of the first object or the first transmission and target information of the second object or the second transmission; or
the at least two pieces of target information include target information of each object or each transmission corresponding to the control information.

In other words, when the control information indicates a plurality of pieces of target information, a cell and/or a transmission in which an SCS scheduled by the control information (PDCCH) is greater than or equal to the PDCCH SCS, and a cell and/or a transmission in which an SCS scheduled by the control information is less than or equal to the PDCCH SCS may need to meet different restrictions.

For example, the target information may be offset information between the transmission and the control information, such as a PDSCH offset K0 and a PUSCH offset K2, such as time domain resource allocation information, such as a CSI-RS request, such as CSI-RS resource allocation information, such as a CSI-RS offset, such as an SRS request, such as SRS resource allocation information, such as an SRS offset, such as a TCI indication. Details are not exhaustively illustrated herein.

It should be noted that the scheduling restriction in the transmission processing method in this implementation of this present disclosure is related to a UE capability and/or a network-side configuration. For example, related parameters in the scheduling restriction may be all reported or configured based on a granularity of the first object or the second object or the third object or the fourth object or the first transmission or the second transmission or the third transmission or the fourth transmission. For example, the related parameters in the scheduling restriction include at least one of the beam switching time X, the scheduling interval, the scheduling offset delta, the time Y required for QCL, the beam switching extra time d1, the extra time d2 required for QCL, the first duration, the first target position, and the second target position.

For example, one X1 is configured for the first object and one X2 is configured for the second object, or the UE reports that X1 is supported for the first object and that X2 supported for the second object.

In summary, in this implementation of this present disclosure, for the control information for scheduling the at least two objects or the at least two transmissions, the terminal and the network-side device determine the scheduling restriction of the control information and/or the target transmission corresponding to the control information, to avoid scheduling failure caused by an inability of the terminal to complete control information processing, a beam adjustment, or other operations in some cells in time due to an insufficient time interval, thereby improving scheduling efficiency of the control information.

To more clearly describe the transmission processing method provided in this implementation of this present disclosure, the following uses several examples for description, where T1 is the first duration, position A is the position of the control information, position B is the position of the target transmission, position T2 is the first target position, position T3 is the second target position, and delta is the scheduling offset.

Example 1: If quantization needs to be considered for at least one cell and/or transmission, quantization needs to be considered for all the cells and/or transmissions.

For example, a PDCCH SCS is 15 kHz, and SCSs of transmissions in four cells 1, 2, 3, and 4 scheduled by the PDCCH are 15 kHz, 15 kHz, 30 kHz, and 60 kHz respectively; and assuming that the first reference SCS and the second reference SCS are PDCCH SCSs, the first transmission is transmissions in cells 1 and 2, and the second transmission is transmissions in cells 3 and 4.

If the target SCS is a smallest SCS in all the scheduled transmissions, that is, 15 kHz: the meeting a scheduling restriction means that an interval between the four scheduled transmissions and the PDCCH needs to be greater than or equal to a quantized time corresponding to T1=delta. For example, the interval between the four scheduled transmissions and the PDCCH is greater than or equal to: an interval between an earliest 15 kHz slot in which an interval between a slot start point and the PDCCH is greater than or equal to T1=delta, and the PDCCH.

Alternatively, the meeting a scheduling restriction means that positions of the four scheduled transmissions are equal to or earlier than the T2 position, where the T2 position is a quantized position based on the target SCS after T1=delta after the PDCCH position A, and for example, the T2 position is an earliest 15 kHz slot after T1=delta after the PDCCH position A.

If the target SCS is a largest SCS in all the scheduled transmissions, that is, 60 kHz:
the meeting a scheduling restriction means that an interval between the four scheduled transmissions and the PDCCH needs to be greater than or equal to a quantized time corresponding to T1=delta. For example, the interval between the four scheduled transmissions and the PDCCH is greater than or equal to: an interval between an earliest 60 kHz slot in which an interval between a slot start point and the PDCCH is greater than or equal to T1=delta, and the PDCCH.

Alternatively, the meeting a scheduling restriction means that positions of the four scheduled transmissions are equal to or earlier than the T2 position, where the T2 position is a quantized position based on a specific transmission SCS after T1=delta after the PDCCH position A, and for example, the T2 position is an earliest 60 kHz slot after T1-delta after the PDCCH position A.

Example 2: If quantization needs to be considered for at least one cell and/or transmission, quantization needs to be considered for only a cell and/or a transmission (second cell and/or transmission) with an SCS higher than the PDCCH SCS; and quantization is not considered for a cell and/or a transmission (first cell and/or transmission) with an SCS lower than the PDCCH SCS.

For example, a PDCCH SCS is 15 kHz, and SCSs of transmissions in four cells 1, 2, 3, and 4 scheduled by the PDCCH are 15 kHz, 15 kHz, 30 kHz, and 60 kHz respectively; and assuming that the first reference SCS and the second reference SCS are PDCCH SCSs, the first transmission is transmissions in cells 1 and 2, and the second transmission is transmissions in cells 3 and 4.

If the third specific SCS is a smallest SCS in the SCSs of the second transmission, that is, 30 kHz:
the meeting a scheduling restriction means that an interval between a scheduled transmission of 30/60 kHz and the PDCCH needs to be greater than or equal to a quantized time corresponding to T1=delta. For example, an interval between two scheduled transmissions and the PDCCH is greater than or equal to: an interval between an earliest 30 kHz slot in which an interval between a slot start point and the PDCCH is greater than or equal to T1=delta, and the PDCCH; and/or an interval between two scheduled transmissions of 15 kHz and the PDCCH needs to be greater than or equal to T1=delta.

Alternatively, the meeting a scheduling restriction means that a position of a scheduled transmission of 30/60 kHz is equal to or earlier than the T2 position, where the T2 position is a quantized position based on the target SCS after T1=delta after the PDCCH position A, and for example, the T2 position is an earliest 15 kHz slot after T1-delta after the PDCCH position A; and/or positions of two scheduled transmissions of 15 kHz are equal to or earlier than the T2 position, where the T2 position is a position after T1=delta after the PDCCH position A.

If the third specific SCS is a smallest SCS in the SCSs of the second transmission, that is, 60 kHz:
the meeting a scheduling restriction means that an interval between a scheduled transmission of 30/60 kHz and the PDCCH needs to be greater than or equal to a quantized time corresponding to T1=delta. For example, an interval between two scheduled transmissions and the PDCCH is greater than or equal to: an interval between an earliest 60 kHz slot in which an interval between a slot start point and the PDCCH is greater than or equal to T1=delta, and the PDCCH; and/or an interval between two scheduled transmissions of 15 kHz and the PDCCH needs to be greater than or equal to T1=delta.

Alternatively, the meeting a scheduling restriction means that a position of a scheduled transmission of 30/60 kHz is equal to or earlier than the T2 position, where the T2 position is a quantized position based on the third specific SCS after T1=delta after the PDCCH position A, and for example, the T2 position is an earliest 60 kHz slot after T1=delta after the PDCCH position A; and/or positions of two scheduled transmissions of 15 kHz are equal to or earlier than the T2 position, where the T2 position is a position after T1=delta after the PDCCH position A.

Example 3: If X or Y is configured for at least one cell and/or transmission, X or Y is configured for all the cells and/or transmissions.

For example, a PDCCH SCS is 15 kHz, and SCSs of transmissions in four cells 1, 2, 3, and 4 scheduled by the PDCCH are 15 kHz, 15 kHz, 30 kHz, and 60 kHz respectively. It is assumed that the third transmission is transmissions in cells 1 and 2 (beam switching does not need to be considered, for example, a TCI is not configured), and the fourth transmission is transmissions in cells 3 and 4 (beam switching needs to be considered, for example, a TCI is indicated).

If the target SCS is a smallest SCS in all the scheduled transmissions, that is, 15 kHz:
the meeting a scheduling restriction means that an interval between the four scheduled transmissions and the PDCCH needs to be greater than or equal to T1=X+d1 or Y+d2, where X or Y is the beam switching time corresponding to 15 kHz or the time required for QCL.

If the specific transmission SCS is a largest SCS in all the scheduled transmissions, that is, 60 kHz:
the meeting a scheduling restriction means that an interval between the four scheduled transmissions and the PDCCH needs to be greater than or equal to T1=X+d1 or Y+d2, where X or Y is the beam switching time corresponding to 60 kHz or the time required for QCL.

Example 4: If X or Y is considered for at least one cell or transmission, X or Y needs to be considered for all the cells or transmissions.

For example, a PDCCH SCS is 15 kHz, and SCSs of transmissions in four cells 1, 2, 3, and 4 scheduled by the PDCCH are 15 kHz, 15 kHz, 30 kHz, and 60 kHz respectively. It is assumed that the third transmission is transmissions in cells 1 and 2 (beam switching does not need to be considered, for example, a TCI is not configured), and the fourth transmission is transmissions in cells 3 and 4 (beam switching needs to be considered, for example, a TCI is indicated).

If the fifth specific SCS is a smallest SCS in the SCSs of the fourth transmission, that is, 30 kHz:
the meeting a scheduling restriction means that an interval between two scheduled transmissions of 30/60 kHz and the PDCCH is greater than or equal to T1=X+d1 or Y+d2, where at least one of X, Y, d1, and d2 is the beam switching time corresponding to 30 kHz or the time required for QCL; and/or
if the fourth specific SCS is a smallest SCS in the third transmission, that is, 15 kHz:
the meeting a scheduling restriction means that an interval between two scheduled transmissions of 15 kHz and the PDCCH needs to be greater than or equal to T1=X or Y, where at least one of X and Y is the beam switching time corresponding to 15 kHz or the time required for QCL.

If the fifth specific SCS is a largest SCS in the fourth transmission, that is, 60 kHz:
the meeting a scheduling restriction means that an interval between two scheduled transmissions of 30/60 kHz and the PDCCH needs to be greater than or equal to T1=X+d1 or Y+d2, where at least one of X, Y, d1, and d2 is the beam switching time corresponding to 60 kHz or the time required for QCL; and/or
if the fourth specific SCS is a largest SCS in the third transmission, that is, 15 kHz:
the meeting a scheduling restriction means that an interval between two scheduled transmissions of 15 kHz and the PDCCH needs to be greater than or equal to T1=X or Y, where at least one of X and Y is the beam switching time corresponding to 15 kHz or the time required for QCL.

Example 5: If d1 or d2 is considered for at least one cell and/or transmission, d1 or d2 needs to be considered for all the cells and/or transmissions.

For example, a PDCCH SCS is 15 kHz, and SCSs of transmissions in four cells 1, 2, 3, and 4 scheduled by the PDCCH are 15 kHz, 15 kHz, 30 kHz, and 60 kHz respectively. It is assumed that the first transmission is transmissions in cells 1 and 2, and the second transmission is transmissions in cells 3 and 4, and beam switching may need to be considered for all the four cells, for example, a TCI is configured or indicated for all the four cells.

If the target SCS is a smallest SCS in the transmission, that is, 15 kHz:
the meeting a scheduling restriction means that an interval between the four scheduled transmissions and the PDCCH needs to be greater than or equal to T1=X+d1 or Y+d2, where for example, X or Y is the beam switching time corresponding to 15 kHz or the time required for QCL.

If the target SCS is a largest SCS in the transmission, that is, 60 kHz:
the meeting a scheduling restriction means that an interval between the four scheduled transmissions and the PDCCH needs to be greater than or equal to T1=X+d1 or Y+d2, where for example, X or Y is the beam switching time corresponding to 60 kHz or the time required for QCL.

Example 6: If d1 or d2 is considered for at least one cell or transmission, d1 or d2 needs to be considered for only a cell or transmission (second cell or transmission) with an SCS higher than the PDCCH SCS, but d1 or d2 does not need to be considered for a cell or transmission (first cell or transmission) with an SCS lower than the PDCCH SCS.

For example, a PDCCH SCS is 15 kHz, and SCSs of transmissions in four cells 1, 2, 3, and 4 scheduled by the PDCCH are 15 kHz, 15 kHz, 30 kHz, and 60 kHz respectively. It is assumed that the first transmission is transmissions in cells 1 and 2, and the second transmission is transmissions in cells 3 and 4, and beam switching may need to be considered for all the four cells, for example, a TCI is configured or indicated for all the four cells.

If the third specific SCS is a smallest SCS in the second transmission, that is, 30 kHz:
the meeting a scheduling restriction means that an interval between two scheduled transmissions of 30/60 kHz and the PDCCH is greater than or equal to T1=X+d1 or Y+d2, where for example, X or Y is the beam switching time corresponding to 30 kHz or the time required for QCL; and/or
if the second specific SCS is a smallest SCS in the first transmission, that is, 15 kHz:
the meeting a scheduling restriction means that an interval between two scheduled transmissions of 15 kHz and the PDCCH needs to be greater than or equal to T1=X or Y, where for example, X or Y is the beam switching time corresponding to 15 kHz or the time required for QCL.

If the third specific SCS is a largest SCS in the second transmission, that is, 60 kHz:
the meeting a scheduling restriction means that an interval between two scheduled transmissions of 30/60 kHz and the PDCCH needs to be greater than or equal to T1=X+d1 or Y+d2, where for example, X or Y is the beam switching time corresponding to 60 kHz or the time required for QCL; and/or
if the first specific SCS is a largest SCS in the first transmission, that is, 15 kHz:
the meeting a scheduling restriction means that an interval between two scheduled transmissions of 15 kHz and the PDCCH needs to be greater than or equal to T1=X or Y, where for example, X or Y is the beam switching time corresponding to 15 kHz or the time required for QCL.

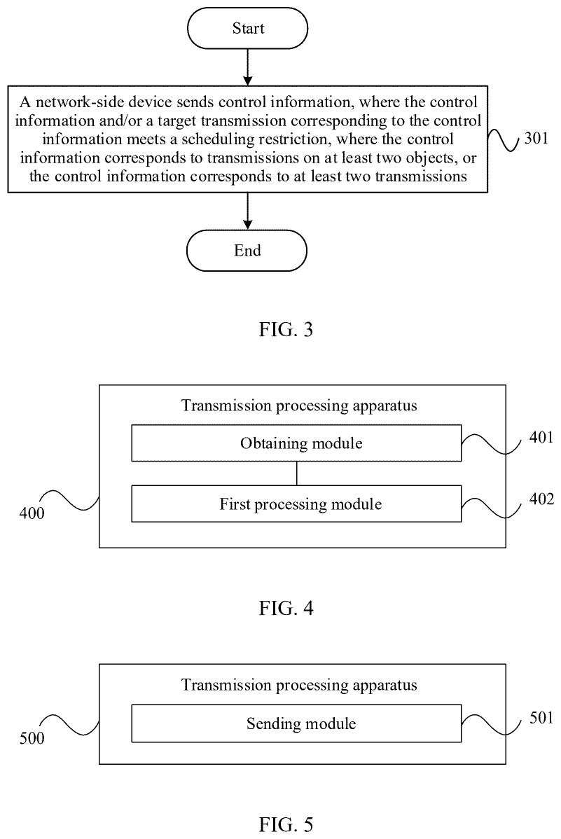

As shown in FIG. 3, an implementation of this present disclosure further provides a transmission processing method, including the following step.

Step 301: A network-side device sends control information, where the control information and/or a target transmission corresponding to the control information meets a scheduling restriction.

The control information corresponds to transmissions on at least two objects, or the control information corresponds to at least two transmissions.

It should be noted that the foregoing objects may be interpreted as a cell, a bandwidth part BWP, a carrier, and the like, and are not specifically limited herein. That the control information corresponds to transmissions on at least two objects may be interpreted as: the control information indicates or schedules or activates or deactivates the transmissions on the at least two objects. That the control information corresponds to at least two transmissions may be interpreted as: the control information indicates or schedules or activates or deactivates the at least two transmissions.

For example, the control information is DCI or a PDCCH.

In at least one implementation of this present disclosure, the target transmission includes at least one of the following items (a)-(j):

Item (a) At least part of one or more transmissions on at least one of the at least two objects corresponding to the control information.

For example, the at least part of the one or more transmissions on the at least one of the at least two objects corresponding to the control information are: the transmissions on all the objects corresponding to the control information.

For example, the at least part of the one or more transmissions on the at least one of the at least two objects corresponding to the control information are: a transmission with an earliest or latest start position in the transmissions on all the objects corresponding to the control information.

For example, the at least part of the one or more transmissions on the at least one of the at least two objects corresponding to the control information are: a transmission with an earliest or latest end position in the transmissions on all the objects corresponding to the control information.

For example, the at least part of the one or more transmissions on the at least one of the at least two objects corresponding to the control information are: a transmission on a primary cell or a special cell or a specific cell or an object including a characteristic resource or transmission (for example, with a largest or smallest SCS).

Item (b) At least one of the at least two transmissions corresponding to the control information.

For example, the at least one of the at least two transmissions corresponding to the control information is: all the transmissions corresponding to the control information.

For example, the at least one of the at least two transmissions corresponding to the control information is: a transmission with an earliest or latest start position in all the transmissions corresponding to the control information.

For example, the at least one of the at least two transmissions corresponding to the control information is: a transmission with an earliest or latest end position in all the transmissions corresponding to the control information.

For example, the at least one of the at least two transmissions corresponding to the control information is: a transmission with a largest or smallest SCS.

Item (c) At least part of one or more transmissions on a first object, where the first object is an object with a subcarrier spacing SCS less than or equal to a first reference SCS in the at least two objects corresponding to the control information, where
the transmission on the first object may be understood as a transmission indicated or scheduled or activated or deactivated by the control information on the first object.

For example, the at least part of the one or more transmissions on the first object include: all the transmissions on the first object.

For example, the at least part of the one or more transmissions on the first object include: a transmission with an earliest start position in all the transmissions on the first object.

For example, the at least part of the one or more transmissions on the first object include: a transmission with a latest start position in all the transmissions on the first object.

For example, the at least part of the one or more transmissions on the first object include: a transmission with an earliest end position in all the transmissions on the first object.

For example, the at least part of the one or more transmissions on the first object include: a transmission with a latest end position in all the transmissions on the first object.

Item (d) A first transmission, where the first transmission is at least part of one or more transmissions with SCSs less than or equal to the first reference SCS in the at least two transmissions corresponding to the control information.

For example, the first transmission is: all the transmissions with SCSs less than or equal to the first reference SCS in the at least two transmissions corresponding to the control information.

For example, the first transmission is: a transmission with an SCS less than or equal to the first reference SCS and with an earliest start position in the at least two transmissions corresponding to the control information.

For example, the first transmission is: a transmission with an SCS less than or equal to the first reference SCS and with a latest start position in the at least two transmissions corresponding to the control information.

For example, the first transmission is: a transmission with an SCS less than or equal to the first reference SCS and with an earliest end position in the at least two transmissions corresponding to the control information.

For example, the first transmission is: a transmission with an SCS less than or equal to the first reference SCS and with a latest end position in the at least two transmissions corresponding to the control information.

Item (e) At least part of one or more transmissions on a second object, where the second object is an object with a subcarrier spacing SCS greater than or equal to a second reference SCS in the at least two objects corresponding to the control information, where
the transmission on the second object may be understood as a transmission indicated or scheduled or activated or deactivated by the control information on the second object.

For example, the at least part of the one or more transmissions on the second object is: all the transmissions on the second object.

For example, the at least part of the one or more transmissions on the second object is: a transmission with an earliest start position in all the transmissions on the second object.

For example, the at least part of the one or more transmissions on the second object is: a transmission with a latest start position in all the transmissions on the second object.

For example, the at least part of the one or more transmissions on the second object is: a transmission with an earliest end position in all the transmissions on the second object.

For example, the at least part of the one or more transmissions on the second object is: a transmission with a latest end position in all the transmissions on the second object.

Item (f) A second transmission, where the second transmission is at least part of one or more transmissions with SCSs greater than or equal to the second reference SCS in the at least two transmissions corresponding to the control information.

For example, the second transmission is: all the transmissions with SCSs greater than or equal to the second reference SCS in the at least two transmissions corresponding to the control information.

For example, the second transmission is: a transmission with an SCS greater than or equal to the second reference SCS and with an earliest start position in the at least two transmissions corresponding to the control information.

For example, the second transmission is: a transmission with an SCS greater than or equal to the second reference SCS and with a latest start position in the at least two transmissions corresponding to the control information.

For example, the second transmission is: a transmission with an SCS greater than or equal to the second reference SCS and with an earliest end position in the at least two transmissions corresponding to the control information.

For example, the second transmission is: a transmission with an SCS greater than or equal to the second reference SCS and with a latest end position in the at least two transmissions corresponding to the control information.

Item (g) At least part of one or more transmissions on a third object, where the third object includes at least one of an object not configured with a transmission configuration indicator TCI or multiple beams or a QCL source, an object without an activated TCI or multiple activated beams or an activated QCL source, an object on which a TCI or multiple beams or a QCL source is activated but does not take effect, an object within a frequency range FR1, and an object not higher than a first preset frequency domain position.

Item (h) A third transmission, where the third transmission includes at least part of: a transmission not configured with a transmission configuration indicator TCI or multiple beams or a QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position.

Item (i) At least part of one or more transmissions on a fourth object, where the fourth object includes at least one of an object configured with a TCI or multiple beams or a QCL source, an object with an activated TCI or multiple activated beams or an activated QCL source, an object on which a TCI or multiple beams or a QCL source is activated and takes effect, an object within a frequency range FR2, and an object not lower than a second preset frequency domain position.

Item (j) A fourth transmission, where the fourth transmission includes at least part of: a transmission configured with a TCI or multiple beams or a QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

For example, the first reference SCS and the second reference SCS may be SCSs of the control information or preset SCSs; and the first reference SCS and the second reference SCS may be a same SCS or different SCSs.

It should be noted that the “transmission” mentioned in this implementation of this present disclosure may be at least one of a sounding reference signal SRS, a demodulation reference signal DMRS, a channel state information reference signal CSI-RS, and a physical downlink shared channel PDSCH; and the transmission may also be interpreted as a transmission resource, that is, a resource that may be used for a transmission but is not actually used for a transmission, or a resource actually used for a transmission.

In an optional implementation of this present disclosure, the meeting a scheduling restriction includes at least one of the following:
an interval between a first position (that is, a position of the control information) corresponding to the control information and a second position (that is, a position of the target transmission) corresponding to the target transmission is greater than or equal to first duration, where the first duration may be referred to as T1;
the second position corresponding to the target transmission is not earlier than a first target position, where the first target position may be referred to as a T2 position; and
the first position corresponding to the control information is not later than a second target position, where the second target position may be referred to as a T3 position.

In another optional implementation of this present disclosure, the not meeting a scheduling restriction includes at least one of the following:
an interval between a first position corresponding to the control information and a second position corresponding to the target transmission is less than or equal to first duration;
the second position corresponding to the target transmission is equal to or earlier than a first target position; and
the first position corresponding to the control information is equal to or later than a second target position.

The first target position is related to the first position and the first duration; and/or the second target position is related to the second position and the first duration.

In an optional implementation, the first target position is:
a time position after the first duration from the first position;
or
an available time position after the first duration from the first position.

In another optional implementation, the second target position is:
a time position that is before the second position and is the first duration away from the second position;
or
an available time position that is before the second position and is the first duration away from the second position.

For example, the available time position is a nearest available time position, or a nearest and latest available time position, or a nearest and earliest available time position, or a nearest available time position earlier than a point, or a latest available time position earlier than a point.

It should be noted that the available time position may also be referred to as a quantized time position. A quantized time position of a position may be understood as a position corresponding to a symbol and/or span and/or slot and/or monitoring occasion and/or subframe and/or frame and/or period nearest (for example, before a time point and nearest, or after a time point and nearest) to the position.

In an optional implementation, the first duration is related to second information, and the second information includes at least one of the following:
a scheduling offset;
a scheduling interval;
a second time required for beam switching; and
a third time required for QCL.

The first duration is a time interval between a position corresponding to a nearest symbol and/or span and/or slot and/or monitoring occasion and/or subframe and/or frame and/or period after the second information is met and the position (that is, the first position) of the control information, and may also be understood as a time interval between the position corresponding to the symbol and/or span and/or slot and/or monitoring occasion and/or subframe and/or frame and/or period after the second information is rounded and the position of the control information.

For example, the first duration is at least one item of the foregoing second information, or a weighted sum of at least two items, or a largest or smallest value of at least two items, or a quantized time of at least one item of the second information, or a quantized time of a weighted sum of at least two items, or a quantized time of a largest value or a smallest value of at least two items, which is not specifically limited herein.

It should be noted that the first position is the position of the control information, and the position of the control information may be understood as: a start position or an end position of a symbol and/or span and/or slot and/or monitoring occasion and/or subframe and/or frame and/or period in which the control information is located or which corresponds to the control information; and for example, the position of the control information is an end position of the PDCCH.

The second position is a position of the target transmission, where the position of the target transmission may be understood as: a start position or an end position of a symbol and/or slot and/or burst and/or set and/or subframe and/or frame and/or period in which the target transmission is located or which corresponds to the target transmission, or a position of a symbol; and for example, the position of the target transmission is a position of a first symbol of the PDSCH.

In at least one implementation of this present disclosure, the scheduling restriction is related to first information, and the first information includes at least one of the following:
an SCS of the control information;
a time domain start point of the control information;
a time domain end point of the control information;
a time unit in which the control information is located;
time domain duration of the control information;
the first position corresponding to the control information, that is, the position of the control information;
a processing time of the control information, for example, a maximum processing time, a minimum processing time, or a preset processing time;
a processing or preparation time for transmission;
a buffering time, for example, a maximum buffering time, a minimum buffering time, or a preset buffering time;
a target SCS;
a second time required for beam switching;
a third time required for QCL;
a scheduling interval;
a scheduling offset;
time domain duration of the target transmission;
a time domain start point of the target transmission;
a time domain end point of the target transmission;
the second position corresponding to the target transmission, that is, the position of the target transmission;
time domain duration of a reference transmission;
a third position corresponding to the reference transmission, that is, a position of the reference transmission; and
a frequency domain position corresponding to the control information.

In at least one implementation of this present disclosure, the reference transmission includes at least one of the following items (a)-(j):

Item (a) At least part of one or more transmissions on at least one of the at least two objects corresponding to the control information.

For example, the at least part of the one or more transmissions on the at least one of the at least two objects corresponding to the control information are: the transmissions on all the objects corresponding to the control information.

For example, the at least part of the one or more transmissions on the at least one of the at least two objects corresponding to the control information are: a transmission with an earliest or latest start position in the transmissions on all the objects corresponding to the control information.

For example, the at least part of the one or more transmissions on the at least one of the at least two objects corresponding to the control information are: a transmission with an earliest or latest end position in the transmissions on all the objects corresponding to the control information.

For example, the at least part of the one or more transmissions on the at least one of the at least two objects corresponding to the control information are: a transmission on a primary cell or a special cell or a specific cell or an object including a characteristic resource or transmission (for example, with a largest or smallest SCS).

Item (b) At least one of the at least two transmissions corresponding to the control information.

For example, the at least one of the at least two transmissions corresponding to the control information is: all the transmissions corresponding to the control information.

For example, the at least one of the at least two transmissions corresponding to the control information is: a transmission with an earliest or latest start position in all the transmissions corresponding to the control information.

For example, the at least one of the at least two transmissions corresponding to the control information is: a transmission with an earliest or latest end position in all the transmissions corresponding to the control information.

For example, the at least one of the at least two transmissions corresponding to the control information is: a transmission with a largest or smallest SCS.

Item (c) At least part of one or more transmissions on a first object, where the first object is an object with a subcarrier spacing SCS less than or equal to the first reference SCS in the at least two objects corresponding to the control information, where the transmission on the first object may be understood as a transmission indicated or scheduled or activated or deactivated by the control information on the first object.

For example, the at least part of the one or more transmissions on the first object include: all the transmissions on the first object.

For example, the at least part of the one or more transmissions on the first object include: a transmission with an earliest start position in all the transmissions on the first object.

For example, the at least part of the one or more transmissions on the first object include: a transmission with a latest start position in all the transmissions on the first object.

For example, the at least part of the one or more transmissions on the first object include: a transmission with an earliest end position in all the transmissions on the first object.

For example, the at least part of the one or more transmissions on the first object include: a transmission with a latest end position in all the transmissions on the first object.

Item (d) A first transmission, where the first transmission is at least part of one or more transmissions with SCSs less than or equal to the first reference SCS in the at least two transmissions corresponding to the control information.

For example, the first transmission is: all the transmissions with SCSs less than or equal to the first reference SCS in the at least two transmissions corresponding to the control information.

For example, the first transmission is: a transmission with an SCS less than or equal to the first reference SCS and with an earliest start position in the at least two transmissions corresponding to the control information.

For example, the first transmission is: a transmission with an SCS less than or equal to the first reference SCS and with a latest start position in the at least two transmissions corresponding to the control information.

For example, the first transmission is: a transmission with an SCS less than or equal to the first reference SCS and with an earliest end position in the at least two transmissions corresponding to the control information.

For example, the first transmission is: a transmission with an SCS less than or equal to the first reference SCS and with a latest end position in the at least two transmissions corresponding to the control information.

Item (e) At least part of one or more transmissions on a second object, where the second object is an object with a subcarrier spacing SCS greater than or equal to the second reference SCS in the at least two objects corresponding to the control information, where
the transmission on the second object may be understood as a transmission indicated or scheduled or activated or deactivated by the control information on the second object.

For example, the at least part of the one or more transmissions on the second object is: all the transmissions on the second object.

For example, the at least part of the one or more transmissions on the second object is: a transmission with an earliest start position in all the transmissions on the second object.

For example, the at least part of the one or more transmissions on the second object is: a transmission with a latest start position in all the transmissions on the second object.

For example, the at least part of the one or more transmissions on the second object is: a transmission with an earliest end position in all the transmissions on the second object.

For example, the at least part of the one or more transmissions on the second object is: a transmission with a latest end position in all the transmissions on the second object.

Item (f) A second transmission, where the second transmission is at least part of one or more transmissions with SCSs greater than or equal to the second reference SCS in the at least two transmissions corresponding to the control information.

For example, the second transmission is: all the transmissions with SCSs greater than or equal to the second reference SCS in the at least two transmissions corresponding to the control information.

For example, the second transmission is: a transmission with an SCS greater than or equal to the second reference SCS and with an earliest start position in the at least two transmissions corresponding to the control information.

For example, the second transmission is: a transmission with an SCS greater than or equal to the second reference SCS and with a latest start position in the at least two transmissions corresponding to the control information.

For example, the second transmission is: a transmission with an SCS greater than or equal to the second reference SCS and with an earliest end position in the at least two transmissions corresponding to the control information.

For example, the second transmission is: a transmission with an SCS greater than or equal to the second reference SCS and with a latest end position in the at least two transmissions corresponding to the control information.

Item (g) At least part of one or more transmissions on a third object, where the third object includes at least one of an object not configured with a transmission configuration indicator TCI or multiple beams or a QCL source, an object without an activated TCI or multiple activated beams or an activated QCL source, an object on which a TCI or multiple beams or a QCL source is activated but does not take effect, an object within the frequency range FR1, and an object not higher than the first preset frequency domain position.

Item (h) A third transmission, where the third transmission includes at least part of: a transmission not configured with a transmission configuration indicator TCI or multiple beams or a QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position.

Item (i) At least part of one or more transmissions on a fourth object, where the fourth object includes at least one of an object configured with a TCI or multiple beams or a QCL source, an object with an activated TCI or multiple activated beams or an activated QCL source, an object on which a TCI or multiple beams or a QCL source is activated and takes effect, an object within the frequency range FR2, and an object not lower than the second preset frequency domain position.

Item (j) A fourth transmission, where the fourth transmission includes at least part of: a transmission configured with a TCI or multiple beams or a QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

A definition range of the reference transmission is the same as a definition range of the target transmission, but the reference transmission and the target transmission may correspond to a same item or different items within the definition range. For example, the target transmission is interpreted as all transmissions scheduled by the PDCCH, while the reference transmission is interpreted as an earliest transmission in all the transmissions scheduled by the PDCCH. Details are not exhaustively described herein.

For example, at least one of the first duration, the first target position, and the second target position is related to the first information. For example, at least one of the scheduling offset Delta or the second time required for beam switching or the scheduling interval K is determined based on the SCS of the control information and/or the target SCS. For example, the quantized time or quantized position is quantized based on the target SCS, that is, quantized to a nearest symbol and/or span and/or slot and/or monitoring occasion and/or subframe and/or frame and/or period calculated based on the target SCS.

In at least one implementation of this present disclosure, the target SCS includes at least one of the following entries (1)-(5):

(1) A first specific SCS, where the first specific SCS is at least part of one or more SCSs of the at least two objects corresponding to the control information or at least part of one or more SCSs of the at least two transmissions corresponding to the control information.

For example, the at least part of the one or more SCSs may be understood as: a largest SCS or a smallest SCS or a preset SCS.

For example, a PDCCH SCS is 15 kHz, and SCSs of transmissions in four scheduled cells 1, 2, 3, and 4 are 15 kHz, 15 kHz, 30 kHz, and 60 kHz respectively; and if the target SCS is a largest one of SCSs of transmissions scheduled by the PDCCH, the target SCS is 60 KHz.

(2) A second specific SCS, where the second specific SCS is at least part of one or more SCSs of the first object or at least part of one or more SCSs of the first transmission.

For example, the at least part of the one or more SCSs may be understood as: a largest SCS or a smallest SCS or a preset SCS.

For example, a PDCCH SCS is 15 kHz, and SCSs of transmissions in four scheduled cells 1, 2, 3, and 4 are 15 kHz, 15 kHz, 30 kHz, and 60 kHz respectively; assuming that the first reference SCS and the second reference SCS are PDCCH SCSs, the first transmission is transmissions in cells 1 and 2, and the second transmission is transmissions in cells 3 and 4; and if the target SCS is a largest one of the SCSs of the first transmission, the target SCS is 15 KHz.

(3) A third specific SCS, where the third specific SCS is at least part of one or more SCSs of the second object or at least part of one or more SCSs of the second transmission.

For example, the at least part of the one or more SCSs may be understood as: a largest SCS or a smallest SCS or a preset SCS.

For example, a PDCCH SCS is 15 kHz, and SCSs of transmissions in four scheduled cells 1, 2, 3, and 4 are 15 kHz, 15 kHz, 30 kHz, and 60 kHz respectively; assuming that the first reference SCS and the second reference SCS are PDCCH SCSs, the first transmission is transmissions in cells 1 and 2, and the second transmission is transmissions in cells 3 and 4; and if the target SCS is a largest one of the SCSs of the first transmission, the target SCS is 15 kHz.

(4) A fourth specific SCS, where the fourth specific SCS is at least part of one or more SCSs of the third object or at least part of one or more SCSs of the third transmission.

For example, the at least part of the one or more SCSs may be understood as: a largest SCS or a smallest SCS or a preset SCS.

(5) A fifth specific SCS, where the fifth specific SCS is at least part of one or more SCSs of the fourth object or at least part of one or more SCSs of the fourth transmission.

For example, the at least part of the one or more SCSs may be understood as: a largest SCS or a smallest SCS or a preset SCS.

In at least one implementation of this present disclosure, the second time required for beam switching includes the beam switching time, or a beam switching time and a beam switching extra time;
and/or
the third time required for QCL includes a time required for QCL, or a time required for QCL and an extra time required for QCL.

For example, the beam switching time beamSwitchTiming may be referred to as X:
the beam switching time is a longest and/or shortest and/or preset beam switching time among beam switching times corresponding to an object and/or a transmission (band or band combination) scheduled by the control information;
the beam switching time is a longest and/or shortest and/or preset beam switching time among beam switching times corresponding to the first cell and/or the first transmission (band or band combination); and
the beam switching time is a longest and/or shortest and/or preset beam switching time among beam switching times corresponding to the second cell and/or the second transmission (band or band combination).

For example, the beam switching extra time beamSwitchTiming may be referred to as d1:
the beam switching extra time is a longest and/or shortest and/or preset beam switching extra time among beam switching extra times corresponding to a cell and/or a transmission (band or band combination) scheduled by the control information;
the beam switching extra time is a longest and/or shortest and/or preset beam switching extra time among beam switching extra times corresponding to the first cell and/or the first transmission (band or band combination); and
the beam switching extra time is a longest and/or shortest and/or preset beam switching extra time among beam switching extra times corresponding to the second cell and/or the second transmission (band or band combination).

For example, the time required for QCL timeDurationForQCL may be referred to as Y: the time required for QCL is a longest and/or shortest and/or preset time required for QCL among times required for QCL corresponding to a cell and/or a transmission (band or band combination) scheduled by the control information;
the time required for QCL is a longest and/or shortest and/or preset time required for QCL among times required for QCL corresponding to the first cell and/or first transmission (band or band combination); and
the time required for QCL is a longest and/or shortest and/or preset time required for QCL among times required for QCL corresponding to the second cell and/or second transmission (band or band combination).

For example, the extra time required for QCL timeDurationForQCL may be referred to as d2:
the extra time required for QCL is a longest and/or shortest and/or preset extra time required for QCL among extra times required for QCL corresponding to a cell and/or a transmission (band or band combination) scheduled by the control information;
the extra time required for QCL is a longest and/or shortest and/or preset extra time required for QCL among extra times required for QCL corresponding to the first cell and/or first transmission (band or band combination); and
the extra time required for QCL is a longest and/or shortest and/or preset extra time required for QCL among extra times required for QCL corresponding to the second cell and/or second transmission (band or band combination).

In still another optional implementation of this present disclosure, the scheduling interval K includes at least one of the following:
a first specific scheduling interval for cross-slot scheduling, for example, a longest or shortest or preset scheduling interval for cross-slot scheduling;
a second specific scheduling interval in scheduling intervals corresponding to the control information, for example, a longest and/or shortest and/or preset scheduling interval in scheduling intervals corresponding to a cell and/or a transmission (band or band combination) scheduled by the control information;
a third specific scheduling interval in scheduling intervals corresponding to the first object, for example, a longest and/or shortest and/or preset scheduling interval in scheduling intervals corresponding to the first cell (band or band combination);
a fourth specific scheduling interval in scheduling intervals corresponding to the first transmission, for example, a longest and/or shortest and/or preset scheduling interval in the scheduling intervals corresponding to the first transmission (band or band combination);
a fifth specific scheduling interval in scheduling intervals corresponding to the second object, for example, a longest and/or shortest and/or preset scheduling interval in scheduling intervals corresponding to the second cell (band or band combination); and
a sixth specific scheduling interval in scheduling intervals corresponding to the second transmission, for example, a longest and/or shortest and/or preset scheduling interval in the scheduling intervals corresponding to the second transmission (band or band combination).

In still another optional implementation of this present disclosure, the scheduling offset delta includes at least one of the following:
a first specific scheduling offset, for example, a largest or smallest or preset scheduling offset;
a second specific scheduling offset in scheduling offsets corresponding to the control information, for example, a longest and/or shortest and/or preset scheduling offset in scheduling offsets corresponding to a cell and/or a transmission (band or band combination) scheduled by the control information;
a third specific scheduling offset in scheduling offsets corresponding to the first object, for example, a largest and/or smallest and/or preset scheduling offset in scheduling offsets corresponding to the first cell (band or band combination);
a fourth specific scheduling offset in scheduling offsets corresponding to the first transmission, for example, a largest and/or smallest and/or preset scheduling offset in the scheduling offsets corresponding to the first transmission (band or band combination);
a fifth specific scheduling offset in scheduling offsets corresponding to the second object, for example, a largest and/or smallest and/or preset scheduling offset in scheduling offsets corresponding to the second cell (band or band combination); and
a sixth specific scheduling offset in scheduling offsets corresponding to the second transmission, for example, a largest and/or smallest and/or preset scheduling offset in the scheduling offsets corresponding to the second transmission (band or band combination).

In an optional implementation, the scheduling restriction is at least related to the first specific SCS in a case that the target transmission is the at least part of the one or more transmissions on the at least one object corresponding to the control information or the at least one transmission corresponding to the control information; that is, all cells and/or transmissions scheduled by the PDCCH need to meet a same scheduling restriction.

For example, if the scheduling restriction includes quantization, the quantization is related to the first specific SCS.

For example, if the scheduling restriction includes X and/or Y, the X and/or Y is related to the first specific SCS.

In an optional implementation, the scheduling restriction is at least related to the second specific SCS in a case that the target transmission is the at least part of the one or more transmissions on the first object or in a case that the target transmission is the first transmission; that is, a cell and/or a transmission in which an SCS scheduled by the PDCCH is less than or equal to the PDCCH SCS need/needs to meet a same scheduling restriction (the restriction may be related to a largest SCS and/or a smallest SCS of the cell and/or transmission less than or equal to the PDCCH SCS); and further, a cell and/or a transmission in which an SCS scheduled by the PDCCH is greater than or equal to the PDCCH SCS meets another scheduling restriction (the restriction may be related to a largest SCS and/or a smallest SCS of the cell and/or transmission greater than or equal to the PDCCH SCS).

For example, if the scheduling restriction includes quantization, the quantization is related to the second specific SCS.

For example, if the scheduling restriction includes X and/or Y, the X and/or Y is related to the second specific SCS.

In an optional implementation, the scheduling restriction is at least related to the third specific SCS in a case that the target transmission is the at least part of the one or more transmissions on the second object or in a case that the target transmission is the second transmission; that is, a cell and/or a transmission in which an SCS scheduled by the PDCCH is greater than or equal to the PDCCH SCS need/needs to meet a same scheduling restriction (the restriction may be related to a largest SCS and/or a smallest SCS of the cell and/or transmission greater than or equal to the PDCCH SCS); and further, a cell and/or a transmission in which an SCS scheduled by the PDCCH is less than or equal to the PDCCH SCS need/needs to meet another scheduling restriction (the restriction may be related to a largest SCS and/or a smallest SCS of the cell and/or transmission less than or equal to the PDCCH SCS).

For example, if the scheduling restriction includes quantization, the quantization is related to the third specific SCS.

For example, if the scheduling restriction includes X and/or Y, the X and/or Y is related to the third specific SCS.

In an optional implementation, the scheduling restriction is at least related to at least one of the first specific SCS, the fourth specific SCS, the fifth specific SCS, and the frequency domain position in a case that the target transmission is the at least part of the one or more transmissions on the third object or in a case that the target transmission is the third transmission.

In an optional implementation, the scheduling restriction is at least related to at least one of the first specific SCS, the fourth specific SCS, the fifth specific SCS, and the frequency domain position in a case that the target transmission is the at least part of the one or more transmissions on the fourth object or in a case that the target transmission is the fourth transmission.

For example, if the scheduling restriction includes X and/or Y, the X and/or Y is related to at least one of the first specific SCS, the fourth specific SCS, the fifth specific SCS, and the frequency domain position.

Further, in at least one implementation of this present disclosure, in a case that the control information includes or is associated with or indicates or corresponds to one piece of target information, the target transmission is the at least part of the one or more transmissions on the at least one object corresponding to the control information (for example, the target transmission is at least part of the one or more transmissions on all the objects corresponding to the control information) or the at least one transmission corresponding to the control information (for example, all the transmissions corresponding to the control information), and the scheduling restriction is at least related to the first specific SCS. In other words, when the control information indicates only a unified piece of target information, all the cells and/or transmissions scheduled by the control information need to meet a same restriction.

For example, the target information may be offset information between the transmission and the control information, such as a PDSCH offset K0 and a PUSCH offset K2, such as time domain resource allocation information, such as a CSI-RS request, such as CSI-RS resource allocation information, such as a CSI-RS offset, such as an SRS request, such as SRS resource allocation information, such as an SRS offset, such as a TCI indication. Details are not exhaustively illustrated herein.

Further, in at least one implementation of this present disclosure, in a case that the control information includes or is associated with or indicates or corresponds to at least two pieces of target information, the target transmission is the at least part of the one or more transmissions on the first object, or the target transmission is the first transmission, and the scheduling restriction is at least related to the second specific SCS, where the at least two pieces of target information include target information of the first object or the first transmission and target information of the second object or the second transmission; or the at least two pieces of target information include target information of each object or each transmission corresponding to the control information.

Alternatively, in a case that the control information includes or is associated with or indicates or corresponds to at least two pieces of target information, the target transmission is the at least part of the one or more transmissions on the second object, or the target transmission is the second transmission, and the scheduling restriction is at least related to the third specific SCS, where the at least two pieces of target information include target information of the first object or the first transmission and target information of the second object or the second transmission; or the at least two pieces of target information include target information of each object or each transmission corresponding to the control information.

In other words, when the control information indicates a plurality of pieces of target information, a cell and/or a transmission in which an SCS scheduled by the control information (PDCCH) is greater than or equal to the PDCCH SCS, and a cell and/or a transmission in which an SCS scheduled by the control information is less than or equal to the PDCCH SCS may need to meet different restrictions.

For example, the target information may be offset information between the transmission and the control information, such as a PDSCH offset K0 and a PUSCH offset K2, such as time domain resource allocation information, such as a CSI-RS request, such as CSI-RS resource allocation information, such as a CSI-RS offset, such as an SRS request, such as SRS resource allocation information, such as an SRS offset, such as a TCI indication. Details are not exhaustively illustrated herein.

It should be noted that the scheduling restriction in the transmission processing method in this implementation of this present disclosure is related to a UE capability and/or a network-side configuration. For example, related parameters in the scheduling restriction may be all reported or configured based on a granularity of the first object or the second object or the third object or the fourth object or the first transmission or the second transmission or the third transmission or the fourth transmission. For example, the related parameters in the scheduling restriction include at least one of the beam switching time X, the scheduling interval, the scheduling offset delta, the time Y required for QCL, the beam switching extra time d1, the extra time d2 required for QCL, the first duration, the first target position, and the second target position.

For example, one X1 is configured for the first object and one X2 is configured for the second object, or the UE reports that X1 is supported for the first object and that X2 supported for the second object.

In summary, in this implementation of this present disclosure, for the control information for scheduling the at least two objects or the at least two transmissions, the terminal and the network-side device determine the scheduling restriction of the control information and/or the target transmission corresponding to the control information, to avoid scheduling failure caused by an inability of the terminal to complete control information processing, a beam adjustment, or other operations in some cells in time due to an insufficient time interval, thereby improving scheduling efficiency of the control information.

The transmission processing method provided in the implementations of this present disclosure may be performed by a transmission processing apparatus. A transmission processing apparatus provided in the implementations of this present disclosure is described by assuming that the transmission processing method is performed by the transmission processing apparatus in the implementations of this present disclosure.

As shown in FIG. 4, an implementation of this present disclosure further provides a transmission processing apparatus 400, including:
an obtaining module 401, configured to obtain control information; and
a first processing module 402, configured to perform a corresponding terminal behavior based on the control information, where
the performing a corresponding terminal behavior based on the control information includes at least one of the following:
performing, based on the control information, a target transmission corresponding to the control information, where the control information and/or the target transmission corresponding to the control information meets a scheduling restriction;
performing, based on the control information, at least part of one or more transmissions corresponding to the control information; and
skipping or discarding, based on the control information, at least part of the one or more transmissions corresponding to the control information, where
the control information corresponds to transmissions on at least two objects, or the control information corresponds to at least two transmissions.

In an optional implementation, the target transmission includes at least one of the following:
at least part of one or more transmissions on at least one of the at least two objects corresponding to the control information;
at least one of the at least two transmissions corresponding to the control information;
at least part of one or more transmissions on a first object, where the first object is an object with a subcarrier spacing SCS less than or equal to a first reference SCS in the at least two objects corresponding to the control information;
a first transmission, where the first transmission is at least part of one or more transmissions with SCSs less than or equal to the first reference SCS in the at least two transmissions corresponding to the control information;
at least part of one or more transmissions on a second object, where the second object is an object with a subcarrier spacing SCS greater than or equal to a second reference SCS in the at least two objects corresponding to the control information;
a second transmission, where the second transmission is at least part of one or more transmissions with SCSs greater than or equal to the second reference SCS in the at least two transmissions corresponding to the control information;
at least part of one or more transmissions on a third object, where the third object includes at least one of an object not configured with a transmission configuration indicator TCI or multiple beams or a quasi-co-location QCL source, an object without an activated TCI or multiple activated beams or an activated QCL source, an object on which a TCI or multiple beams or a QCL source is activated but does not take effect, an object within a frequency range FR1, and an object not higher than a first preset frequency domain position;
a third transmission, where the third transmission includes at least part of: a transmission not configured with a transmission configuration indicator TCI or multiple beams or a quasi-co-location QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position;
at least part of one or more transmissions on a fourth object, where the fourth object includes at least one of an object configured with a TCI or multiple beams or a quasi-co-location QCL source, an object with an activated TCI or multiple activated beams or an activated QCL source, an object on which a TCI or multiple beams or a QCL source is activated and takes effect, an object within a frequency range FR2, and an object not lower than a second preset frequency domain position; and
a fourth transmission, where the fourth transmission includes at least part of: a transmission configured with a TCI or multiple beams or a quasi-co-location QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

In an optional implementation, the meeting a scheduling restriction includes at least one of the following:
an interval between a first position corresponding to the control information and a second position corresponding to the target transmission is greater than or equal to first duration;
the second position corresponding to the target transmission is not earlier than a first target position; and
the first position corresponding to the control information is not later than a second target position.

In an optional implementation, the not meeting a scheduling restriction includes at least one of the following:
an interval between a first position corresponding to the control information and a second position corresponding to the target transmission is less than or equal to first duration;
the second position corresponding to the target transmission is equal to or earlier than a first target position; and
the first position corresponding to the control information is equal to or later than a second target position.

In an optional implementation, the method further includes at least one of the following: a first determining module, configured to determine the QCL source or a beam switching time in a corresponding manner based on whether an interval between a first position corresponding to the control information and a second position corresponding to the target transmission is greater than or equal to first duration;
a second determining module, configured to determine the QCL source or the beam switching time in a corresponding manner based on whether the second position is not earlier than a first target position; and
a third determining module, configured to determine the QCL source or the beam switching time in a corresponding manner based on whether the first position is not later than a second target position.

In an optional implementation, the first target position is related to the first position and the first duration; and/or
the second target position is related to the second position and the first duration.

In an optional implementation, the first target position is:
a time position after the first duration from the first position;
or
an available time position after the first duration from the first position.

In an optional implementation, the second target position is:
a time position that is before the second position and is the first duration away from the second position;
or
an available time position that is before the second position and is the first duration away from the second position.

In an optional implementation, the scheduling restriction is related to first information, and the first information includes at least one of the following:
an SCS of the control information;
a time domain start point of the control information;
a time domain end point of the control information;
a time unit in which the control information is located;
time domain duration of the control information;
the first position corresponding to the control information;
a processing time of the control information;
a processing or preparation time for transmission;
a buffering time;
a target SCS;
a second time required for beam switching;
a third time required for QCL;
a scheduling interval;
a scheduling offset;
time domain duration of the target transmission;
a time domain start point of the target transmission;
a time domain end point of the target transmission;
the second position corresponding to the target transmission;
time domain duration of a reference transmission;
a third position corresponding to the reference transmission; and
a frequency domain position corresponding to the control information.

In an optional implementation, at least one of the first duration, the first target position, and the second target position is related to the first information.

In an optional implementation, the target SCS includes at least one of the following:
a first specific SCS, where the first specific SCS is at least part of one or more SCSs of the at least two objects corresponding to the control information or at least part of one or more SCSs of the at least two transmissions corresponding to the control information;
a second specific SCS, where the second specific SCS is at least part of one or more SCSs of the first object or at least part of one or more SCSs of the first transmission;
a third specific SCS, where the third specific SCS is at least part of one or more SCSs of the second object or at least part of one or more SCSs of the second transmission;
a fourth specific SCS, where the fourth specific SCS is at least part of one or more SCSs of the third object or at least part of one or more SCSs of the third transmission; and
a fifth specific SCS, where the fifth specific SCS is at least part of one or more SCSs of the fourth object or at least part of one or more SCSs of the fourth transmission.

In an optional implementation, the reference transmission includes at least one of the following:
at least part of one or more transmissions on at least one of the at least two objects corresponding to the control information;
at least one of the at least two transmissions corresponding to the control information;
at least part of one or more transmissions on a first object, where the first object is an object with a subcarrier spacing SCS less than or equal to the first reference SCS in the at least two objects corresponding to the control information;
a first transmission, where the first transmission is at least part of one or more transmissions with SCSs less than or equal to the first reference SCS in the at least two transmissions corresponding to the control information;
at least part of one or more transmissions on a second object, where the second object is an object with a subcarrier spacing SCS greater than or equal to the second reference SCS in the at least two objects corresponding to the control information;
a second transmission, where the second transmission is at least part of one or more transmissions with SCSs greater than or equal to the second reference SCS in the at least two transmissions corresponding to the control information;
at least part of one or more transmissions on a third object, where the third object includes at least one of an object not configured with a transmission configuration indicator TCI or multiple beams or a quasi-co-location QCL source, an object without an activated TCI or multiple activated beams or an activated QCL source, an object on which a TCI or multiple beams or a QCL source is activated but does not take effect, an object within the frequency range FR1, and an object not higher than the first preset frequency domain position;
a third transmission, where the third transmission includes at least part of: a transmission not configured with a transmission configuration indicator TCI or multiple beams or a quasi-co-location QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position;
at least part of one or more transmissions on a fourth object, where the fourth object includes at least one of an object configured with a TCI or multiple beams or a quasi-co-location QCL source, an object with an activated TCI or multiple activated beams or an activated QCL source, an object on which a TCI or multiple beams or a QCL source is activated and takes effect, an object within the frequency range FR2, and an object not lower than the second preset frequency domain position; and
a fourth transmission, where the fourth transmission includes at least part of: a transmission configured with a TCI or multiple beams or a quasi-co-location QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

In an optional implementation, the first transmission is at least one of the following:
all the transmissions with SCSs less than or equal to the first reference SCS in the at least two transmissions corresponding to the control information;
a transmission with an SCS less than or equal to the first reference SCS and with an earliest start position in the at least two transmissions corresponding to the control information;
a transmission with an SCS less than or equal to the first reference SCS and with a latest start position in the at least two transmissions corresponding to the control information;
a transmission with an SCS less than or equal to the first reference SCS and with an earliest end position in the at least two transmissions corresponding to the control information; and
a transmission with an SCS less than or equal to the first reference SCS and with a latest end position in the at least two transmissions corresponding to the control information.

In an optional implementation, the second transmission is at least one of the following:
all the transmissions with SCSs greater than or equal to the second reference SCS in the at least two transmissions corresponding to the control information;
a transmission with an SCS greater than or equal to the second reference SCS and with an earliest start position in the at least two transmissions corresponding to the control information;
a transmission with an SCS greater than or equal to the second reference SCS and with a latest start position in the at least two transmissions corresponding to the control information;
a transmission with an SCS greater than or equal to the second reference SCS and with an earliest end position in the at least two transmissions corresponding to the control information; and
a transmission with an SCS greater than or equal to the second reference SCS and with a latest end position in the at least two transmissions corresponding to the control information.

In an optional implementation, the at least part of the one or more transmissions on the first object include at least one of the following:
all the transmissions on the first object;
a transmission with an earliest start position in all the transmissions on the first object;
a transmission with a latest start position in all the transmissions on the first object;
a transmission with an earliest end position in all the transmissions on the first object; and
a transmission with a latest end position in all the transmissions on the first object.

In an optional implementation, the at least part of the one or more transmissions on the second object include at least one of the following:
all the transmissions on the second object;
a transmission with an earliest start position in all the transmissions on the second object;
a transmission with a latest start position in all the transmissions on the second object;
a transmission with an earliest end position in all the transmissions on the second object; and
a transmission with a latest end position in all the transmissions on the second object.

In an optional implementation, the first duration is related to second information, and the second information includes at least one of the following:
a scheduling offset;
a scheduling interval;
a second time required for beam switching; and
a third time required for QCL.

In an optional implementation, the second time required for beam switching includes the beam switching time, or a beam switching time and a beam switching extra time;
and/or
the third time required for QCL includes a time required for QCL, or a time required for QCL and an extra time required for QCL.

In an optional implementation, the scheduling interval includes at least one of the following:
a first specific scheduling interval for cross-slot scheduling;
a second specific scheduling interval in scheduling intervals corresponding to the control information;
a third specific scheduling interval in scheduling intervals corresponding to the first object;
a fourth specific scheduling interval in scheduling intervals corresponding to the first transmission;
a fifth specific scheduling interval in scheduling intervals corresponding to the second object; and
a sixth specific scheduling interval in scheduling intervals corresponding to the second transmission.

In an optional implementation, the scheduling offset includes at least one of the following:
a first specific scheduling offset;
a second specific scheduling offset in scheduling offsets corresponding to the control information;
a third specific scheduling offset in scheduling offsets corresponding to the first object;
a fourth specific scheduling offset in scheduling offsets corresponding to the first transmission;
a fifth specific scheduling offset in scheduling offsets corresponding to the second object; and
a sixth specific scheduling offset in scheduling offsets corresponding to the second transmission.

In an optional implementation, the scheduling restriction is at least related to the first specific SCS in a case that the target transmission is the at least part of the one or more transmissions on the at least one object corresponding to the control information or the at least one transmission corresponding to the control information;
or
the scheduling restriction is at least related to the second specific SCS in a case that the target transmission is the at least part of the one or more transmissions on the first object or in a case that the target transmission is the first transmission;
or
the scheduling restriction is at least related to the third specific SCS in a case that the target transmission is the at least part of the one or more transmissions on the second object or in a case that the target transmission is the second transmission;
or
the scheduling restriction is at least related to at least one of the first specific SCS, the fourth specific SCS, the fifth specific SCS, and the frequency domain position in a case that the target transmission is the at least part of the one or more transmissions on the third object or in a case that the target transmission is the third transmission;
or
the scheduling restriction is at least related to at least one of the first specific SCS, the fourth specific SCS, the fifth specific SCS, and the frequency domain position in a case that the target transmission is the at least part of the one or more transmissions on the fourth object or in a case that the target transmission is the fourth transmission.

In an optional implementation, in a case that the control information includes or is associated with or indicates or corresponds to one piece of target information, the target transmission is the at least part of the one or more transmissions on the at least one object corresponding to the control information or the at least one transmission corresponding to the control information, and the scheduling restriction is at least related to the first specific SCS.

In an optional implementation, in a case that the control information includes or is associated with or indicates or corresponds to at least two pieces of target information, the target transmission is the at least part of the one or more transmissions on the first object, or the target transmission is the first transmission, and the scheduling restriction is at least related to the second specific SCS, where the at least two pieces of target information include target information of the first object or the first transmission and target information of the second object or the second transmission; or the at least two pieces of target information include target information of each object or each transmission corresponding to the control information.

In an optional implementation, in a case that the control information includes or is associated with or indicates or corresponds to at least two pieces of target information, the target transmission is the at least part of the one or more transmissions on the second object, or the target transmission is the second transmission, and the scheduling restriction is at least related to the third specific SCS, where
the at least two pieces of target information include target information of the first object or the first transmission and target information of the second object or the second transmission; or
the at least two pieces of target information include target information of each object or each transmission corresponding to the control information.

In an optional implementation, a transmission module includes:
a transmission submodule, configured to perform, based on the received control information, a transmission that meets the scheduling restriction in the transmissions corresponding to the control information.

In an optional implementation, the first processing module includes:
a processing submodule, configured to skip or discard, based on the received control information, a transmission that does not meet the scheduling restriction in the transmissions corresponding to the control information.

In this implementation of this present disclosure, for the control information for scheduling the at least two objects or the at least two transmissions, the terminal and the network-side device determine the scheduling restriction of the control information and/or the target transmission corresponding to the control information, to avoid scheduling failure caused by an inability of the terminal to complete control information processing, a beam adjustment, or other operations in some cells in time due to an insufficient time interval, thereby improving scheduling efficiency of the control information.

It should be noted that the transmission processing apparatus provided in this implementation of this present disclosure is an apparatus capable of performing the foregoing transmission processing method, and all implementations of the foregoing transmission processing method are applicable to the apparatus.

As shown in FIG. 5, an implementation of this present disclosure further provides a transmission processing apparatus 500, including:
a sending module 501, configured to send control information, where the control information and/or a target transmission corresponding to the control information meets a scheduling restriction, where
the control information corresponds to transmissions on at least two objects, or the control information corresponds to at least two transmissions.

In an optional implementation, the target transmission includes at least one of the following:
at least part of one or more transmissions on at least one of the at least two objects corresponding to the control information;
at least one of the at least two transmissions corresponding to the control information;
at least part of one or more transmissions on a first object, where the first object is an object with a subcarrier spacing SCS less than or equal to a first reference SCS in the at least two objects corresponding to the control information;
a first transmission, where the first transmission is at least part of one or more transmissions with SCSs less than or equal to the first reference SCS in the at least two transmissions corresponding to the control information;
at least part of one or more transmissions on a second object, where the second object is an object with a subcarrier spacing SCS greater than or equal to a second reference SCS in the at least two objects corresponding to the control information;
a second transmission, where the second transmission is at least part of one or more transmissions with SCSs greater than or equal to the second reference SCS in the at least two transmissions corresponding to the control information;
at least part of one or more transmissions on a third object, where the third object includes at least one of an object not configured with a transmission configuration indicator TCI or multiple beams or a quasi-co-location QCL source, an object without an activated TCI or multiple activated beams or an activated QCL source, an object on which a TCI or multiple beams or a QCL source is activated but does not take effect, an object within a frequency range FR1, and an object not higher than a first preset frequency domain position;
a third transmission, where the third transmission includes at least part of: a transmission not configured with a transmission configuration indicator TCI or multiple beams or a quasi-co-location QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position;
at least part of one or more transmissions on a fourth object, where the fourth object includes at least one of an object configured with a TCI or multiple beams or a quasi-co-location QCL source, an object with an activated TCI or multiple activated beams or an activated QCL source, an object on which a TCI or multiple beams or a QCL source is activated and takes effect, an object within a frequency range FR2, and an object not lower than a second preset frequency domain position; and
a fourth transmission, where the fourth transmission includes at least part of: a transmission configured with a TCI or multiple beams or a quasi-co-location QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

In an optional implementation, the meeting a scheduling restriction includes at least one of the following:
an interval between a first position corresponding to the control information and a second position corresponding to the target transmission is greater than or equal to first duration;
the second position corresponding to the target transmission is not earlier than a first target position; and
the first position corresponding to the control information is not later than a second target position.

In an optional implementation, the first target position is related to the first position and the first duration; and/or the second target position is related to the second position and the first duration.

In an optional implementation, the first target position is:
a time position after the first duration from the first position;
or
an available time position after the first duration from the first position.

In an optional implementation, the second target position is:
a time position that is before the second position and is the first duration away from the second position;
or
an available time position that is before the second position and is the first duration away from the second position.

In an optional implementation, the scheduling restriction is related to first information, and the first information includes at least one of the following:
an SCS of the control information;
a time domain start point of the control information;
a time domain end point of the control information;
a time unit in which the control information is located;
time domain duration of the control information;
the first position corresponding to the control information;
a processing time of the control information;
a processing or preparation time for transmission;
a buffering time;
a target SCS;
a second time required for beam switching;
a third time required for QCL;
a scheduling interval;
a scheduling offset;
time domain duration of the target transmission;
a time domain start point of the target transmission;
a time domain end point of the target transmission;
the second position corresponding to the target transmission;
time domain duration of a reference transmission;
a third position corresponding to the reference transmission; and
a frequency domain position corresponding to the control information.

In an optional implementation, at least one of the first duration, the first target position, and the second target position is related to the first information.

In an optional implementation, the target SCS includes at least one of the following:
a first specific SCS, where the first specific SCS is at least part of one or more SCSs of the at least two objects corresponding to the control information or at least part of one or more SCSs of the at least two transmissions corresponding to the control information;
a second specific SCS, where the second specific SCS is at least part of one or more SCSs of the first object or at least part of one or more SCSs of the first transmission;
a third specific SCS, where the third specific SCS is at least part of one or more SCSs of the second object or at least part of one or more SCSs of the second transmission;
a fourth specific SCS, where the fourth specific SCS is at least part of one or more SCSs of the third object or at least part of one or more SCSs of the third transmission; and
a fifth specific SCS, where the fifth specific SCS is at least part of one or more SCSs of the fourth object or at least part of one or more SCSs of the fourth transmission.

In an optional implementation, the reference transmission includes at least one of the following:
at least part of one or more transmissions on at least one of the at least two objects corresponding to the control information;
at least one of the at least two transmissions corresponding to the control information;
at least part of one or more transmissions on a first object, where the first object is an object with a subcarrier spacing SCS less than or equal to the first reference SCS in the at least two objects corresponding to the control information;
a first transmission, where the first transmission is at least part of one or more transmissions with SCSs less than or equal to the first reference SCS in the at least two transmissions corresponding to the control information;
at least part of one or more transmissions on a second object, where the second object is an object with a subcarrier spacing SCS greater than or equal to the second reference SCS in the at least two objects corresponding to the control information;
a second transmission, where the second transmission is at least part of one or more transmissions with SCSs greater than or equal to the second reference SCS in the at least two transmissions corresponding to the control information;
at least part of one or more transmissions on a third object, where the third object includes at least one of an object not configured with a transmission configuration indicator TCI or multiple beams or a quasi-co-location QCL source, an object without an activated TCI or multiple activated beams or an activated QCL source, an object on which a TCI or multiple beams or a QCL source is activated but does not take effect, an object within the frequency range FR1, and an object not higher than the first preset frequency domain position;
a third transmission, where the third transmission includes at least part of: a transmission not configured with a transmission configuration indicator TCI or multiple beams or a quasi-co-location QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position;
at least part of one or more transmissions on a fourth object, where the fourth object includes at least one of an object configured with a TCI or multiple beams or a quasi-co-location QCL source, an object with an activated TCI or multiple activated beams or an activated QCL source, an object on which a TCI or multiple beams or a QCL source is activated and takes effect, an object within the frequency range FR2, and an object not lower than the second preset frequency domain position; and
a fourth transmission, where the fourth transmission includes at least part of: a transmission configured with a TCI or multiple beams or a quasi-co-location QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

In an optional implementation, the first transmission is at least one of the following:
all the transmissions with SCSs less than or equal to the first reference SCS in the at least two transmissions corresponding to the control information;
a transmission with an SCS less than or equal to the first reference SCS and with an earliest start position in the at least two transmissions corresponding to the control information;
a transmission with an SCS less than or equal to the first reference SCS and with a latest start position in the at least two transmissions corresponding to the control information;
a transmission with an SCS less than or equal to the first reference SCS and with an earliest end position in the at least two transmissions corresponding to the control information; and
a transmission with an SCS less than or equal to the first reference SCS and with a latest end position in the at least two transmissions corresponding to the control information.

In an optional implementation, the second transmission is at least one of the following: all the transmissions with SCSs greater than or equal to the second reference SCS in the at least two transmissions corresponding to the control information;
a transmission with an SCS greater than or equal to the second reference SCS and with an earliest start position in the at least two transmissions corresponding to the control information;
a transmission with an SCS greater than or equal to the second reference SCS and with a latest start position in the at least two transmissions corresponding to the control information;
a transmission with an SCS greater than or equal to the second reference SCS and with an earliest end position in the at least two transmissions corresponding to the control information;
and a transmission with an SCS greater than or equal to the second reference SCS and with a latest end position in the at least two transmissions corresponding to the control information.

In an optional implementation, the at least part of the one or more transmissions on the first object include at least one of the following:
all the transmissions on the first object;
a transmission with an earliest start position in all the transmissions on the first object;
a transmission with a latest start position in all the transmissions on the first object;
a transmission with an earliest end position in all the transmissions on the first object;
and a transmission with a latest end position in all the transmissions on the first object.

In an optional implementation, the at least part of the one or more transmissions on the second object include at least one of the following:
all the transmissions on the second object;
a transmission with an earliest start position in all the transmissions on the second object;
a transmission with a latest start position in all the transmissions on the second object;
a transmission with an earliest end position in all the transmissions on the second object; and
a transmission with a latest end position in all the transmissions on the second object.

In an optional implementation, the first duration is related to second information, and the second information includes at least one of the following:
a scheduling offset;
a scheduling interval;
a second time required for beam switching; and
a third time required for QCL.

In an optional implementation, the second time required for beam switching includes the beam switching time, or a beam switching time and a beam switching extra time;
and/or
the third time required for QCL includes a time required for QCL, or a time required for QCL and an extra time required for QCL.

In an optional implementation, the scheduling interval includes at least one of the following:
a first specific scheduling interval for cross-slot scheduling;
a second specific scheduling interval in scheduling intervals corresponding to the control information;
a third specific scheduling interval in scheduling intervals corresponding to the first object;
a fourth specific scheduling interval in scheduling intervals corresponding to the first transmission;
a fifth specific scheduling interval in scheduling intervals corresponding to the second object; and
a sixth specific scheduling interval in scheduling intervals corresponding to the second transmission.

In an optional implementation, the scheduling offset includes at least one of the following:
a first specific scheduling offset;
a second specific scheduling offset in scheduling offsets corresponding to the control information;
a third specific scheduling offset in scheduling offsets corresponding to the first object;
a fourth specific scheduling offset in scheduling offsets corresponding to the first transmission;
a fifth specific scheduling offset in scheduling offsets corresponding to the second object; and
a sixth specific scheduling offset in scheduling offsets corresponding to the second transmission.

In an optional implementation, the scheduling restriction is at least related to the first specific SCS in a case that the target transmission is the at least part of the one or more transmissions on the at least one object corresponding to the control information or the at least one transmission corresponding to the control information;
or
the scheduling restriction is at least related to the second specific SCS in a case that the target transmission is the at least part of the one or more transmissions on the first object or in a case that the target transmission is the first transmission;
or
the scheduling restriction is at least related to the third specific SCS in a case that the target transmission is the at least part of the one or more transmissions on the second object or in a case that the target transmission is the second transmission;
or
the scheduling restriction is at least related to at least one of the first specific SCS, the fourth specific SCS, the fifth specific SCS, and the frequency domain position in a case that the target transmission is the at least part of the one or more transmissions on the third object or in a case that the target transmission is the third transmission;
or
the scheduling restriction is at least related to at least one of the first specific SCS, the fourth specific SCS, the fifth specific SCS, and the frequency domain position in a case that the target transmission is the at least part of the one or more transmissions on the fourth object or in a case that the target transmission is the fourth transmission.

In an optional implementation, in a case that the control information includes or is associated with or indicates or corresponds to one piece of target information, the target transmission is the at least part of the one or more transmissions on the at least one object corresponding to the control information or the at least one transmission corresponding to the control information, and the scheduling restriction is at least related to the first specific SCS.

In an optional implementation, in a case that the control information includes or is associated with or indicates or corresponds to at least two pieces of target information, the target transmission is the at least part of the one or more transmissions on the first object, or the target transmission is the first transmission, and the scheduling restriction is at least related to the second specific SCS, where
the at least two pieces of target information include target information of the first object or the first transmission and target information of the second object or the second transmission; or
the at least two pieces of target information include target information of each object or each transmission corresponding to the control information.

In an optional implementation, in a case that the control information includes or is associated with or indicates or corresponds to at least two pieces of target information, the target transmission is the at least part of the one or more transmissions on the second object, or the target transmission is the second transmission, and the scheduling restriction is at least related to the third specific SCS, where
the at least two pieces of target information include target information of the first object or the first transmission and target information of the second object or the second transmission; or
the at least two pieces of target information include target information of each object or each transmission corresponding to the control information.

In this implementation of this present disclosure, for the control information for scheduling the at least two objects or the at least two transmissions, the terminal and the network-side device determine the scheduling restriction of the control information and/or the target transmission corresponding to the control information, to avoid scheduling failure caused by an inability of the terminal to complete control information processing, a beam adjustment, or other operations in some cells in time due to an insufficient time interval, thereby improving scheduling efficiency of the control information.

It should be noted that the transmission processing apparatus provided in this implementation of this present disclosure is an apparatus capable of performing the foregoing transmission processing method, and all implementations of the foregoing transmission processing method are applicable to the apparatus.

The transmission processing apparatus in this implementation of this present disclosure may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a Network Attached Storage (NAS), and the like. This is not specifically limited in this implementation of this present disclosure.

The transmission processing apparatus provided in this implementation of this present disclosure can implement each process implemented in the method implementations in FIG. 1 to FIG. 3, with the same technical effect achieved. To avoid repetition, details are not described herein again.

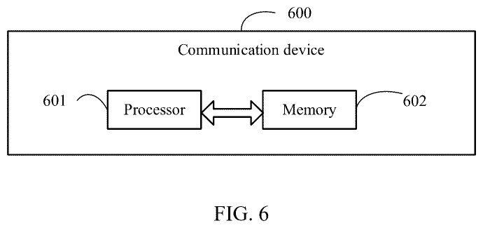

For example, as shown in FIG. 6, an implementation of this present disclosure further provides a communication device 600, including a processor 601 and a memory 602. The memory 602 stores a program or instructions capable of running on the processor 601. For example, when the communication device 600 is a terminal, and the program or instructions are executed by the processor 601, the steps of the foregoing transmission processing method implementation are implemented, with the same technical effect achieved. When the communication device 600 is a network-side device, and the program or instructions are executed by the processor 601, the steps of the foregoing transmission processing method implementation are implemented, with the same technical effect achieved. To avoid repetition, details are not described herein again.

An implementation of this present disclosure further provides a terminal, including a processor and a communication interface. The communication interface is configured to obtain control information; and the processor is configured to perform a corresponding terminal behavior based on the control information, where
the performing, by the terminal, a corresponding terminal behavior based on the control information includes at least one of the following:
performing, based on the control information, a target transmission corresponding to the control information, where the control information and/or the target transmission corresponding to the control information meets a scheduling restriction;
performing, based on the control information, at least part of one or more transmissions corresponding to the control information; and
skipping or discarding, based on the control information, at least part of the one or more transmissions corresponding to the control information, where
the control information corresponds to transmissions on at least two objects, or the control information corresponds to at least two transmissions.

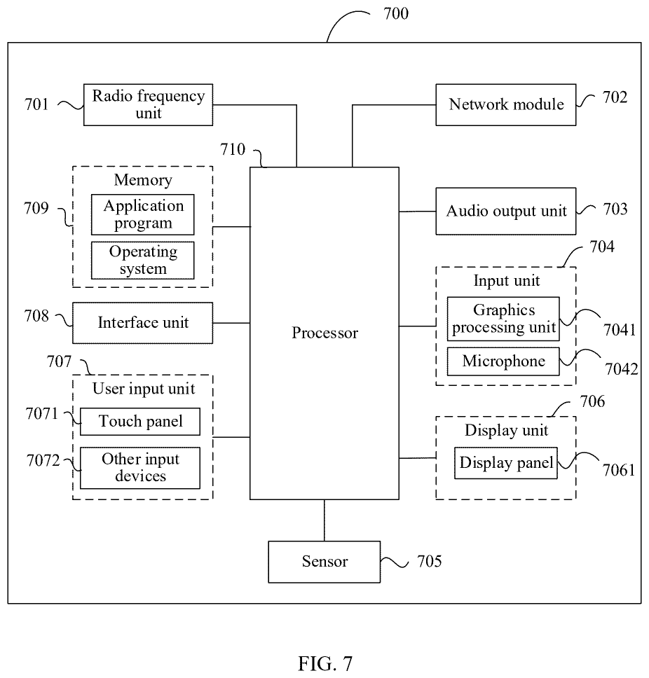

The terminal implementation corresponds to the foregoing terminal-side method implementation, and each implementation process and implementation of the foregoing method implementation can be applied to the terminal implementation, with the same technical effect achieved. For example, FIG. 7 is a schematic diagram of a hardware structure of a terminal for implementing an implementation of this present disclosure.

The terminal 700 includes but is not limited to at least some components such as a radio frequency unit 701, a network module 702, an audio output unit 703, an input unit 704, a sensor 705, a display unit 706, a user input unit 707, an interface unit 708, a memory 709, and a processor 710.

A person skilled in the art may understand that the terminal 700 may further include a power supply (for example, a battery) supplying power to all components. For example, the power supply may be logically connected to the processor 710 through a power management system. In this way, functions such as charge management, discharge management, and power consumption management are implemented by using the power management system. The terminal structure shown in FIG. 7 does not constitute a limitation on the terminal. The terminal may include more or fewer components than those shown in the figure, or some components are combined, or component arrangements are different. Details are not described herein again.

It should be understood that, in this implementation of this present disclosure, the input unit 704 may include a Graphics Processing Unit (GPU) 7041 and a microphone 7042. The graphics processing unit 7041 processes image data of a still picture or video obtained by an image capture apparatus (such as a camera) in a video capture mode or an image capture mode. The display unit 706 may include a display panel 7061, and the display panel 7061 may be configured in a form of a liquid crystal display, an organic light-emitting diode, or the like. The user input unit 707 includes at least one of a touch panel 7071 and other input devices 7072. The touch panel 7071 is also referred to as a touchscreen. The touch panel 7071 may include two parts: a touch detection apparatus and a touch controller. The other input devices 7072 may include but are not limited to a physical keyboard, a function button (such as a volume control button or a power button), a trackball, a mouse, and a joystick. Details are not described herein again.

In this implementation of this present disclosure, after receiving downlink data from a network-side device, the radio frequency unit 701 may transmit the downlink data to the processor 710 for processing. In addition, the radio frequency unit 701 may send uplink data to the network-side device. Usually, the radio frequency unit 701 includes but is not limited to an antenna, an amplifier, a transceiver, a coupler, a low noise amplifier, a duplexer, and the like.

The memory 709 may be configured to store software programs or instructions and various data. The memory 709 may primarily include a first storage area for storing programs or instructions and a second storage area for storing data. The first storage area may store an operating system, an application program or instructions required by at least one function (such as an audio play function and an image play function), and the like. In addition, the memory 709 may include a volatile memory or a non-volatile memory, or the memory 709 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data rate SDRAM (DDR SDRAM), an Enhanced SDRAM (ESDRAM), a Synch Link DRAM (SLDRAM), and a Direct Rambus RAM (DRRAM). The memory 709 in this implementation of this present disclosure includes but is not limited to these and any other suitable types of memories.

The processor 710 may include one or more processing units. For example, the processor 710 integrates an application processor and a modem processor. The application processor mainly processes operations related to the operating system, a user interface, an application program, and the like. The modem processor mainly processes a wireless communication signal. For example, the modem processor is a baseband processor. In some implementations, it may be understood that the modem processor may be not integrated in the processor 710.

The radio frequency unit 701 is configured to obtain control information; and
the processor 710 is configured to perform a corresponding terminal behavior based on the control information, where
the performing, by the terminal, a corresponding terminal behavior based on the control information includes at least one of the following:
performing, based on the control information, a target transmission corresponding to the control information, where the control information and/or the target transmission corresponding to the control information meets a scheduling restriction;
performing, based on the control information, at least part of one or more transmissions corresponding to the control information; and
skipping or discarding, based on the control information, at least part of the one or more transmissions corresponding to the control information, where
the control information corresponds to transmissions on at least two objects, or the control information corresponds to at least two transmissions.

In this implementation of this present disclosure, for the control information for scheduling the at least two objects or the at least two transmissions, the terminal and the network-side device determine the scheduling restriction of the control information and/or the target transmission corresponding to the control information, to avoid scheduling failure caused by an inability of the terminal to complete control information processing, a beam adjustment, or other operations in some cells in time due to an insufficient time interval, thereby improving scheduling efficiency of the control information.

It should be noted that the terminal provided in this implementation of this present disclosure is a terminal capable of performing the foregoing transmission processing method, and all implementations of the foregoing transmission processing method are applicable to the terminal.

An implementation of this present disclosure further provides a network-side device, including a processor and a communication interface. The processor is configured to ensure that control information and/or a target transmission corresponding to the control information meets a scheduling restriction, where the control information corresponds to transmissions on at least two objects, or the control information corresponds to at least two transmissions. The network-side device implementation corresponds to the foregoing method implementation of the network-side device, and each implementation process and implementation of the foregoing method implementation can be applied to the network-side device implementation, with the same technical effect achieved.

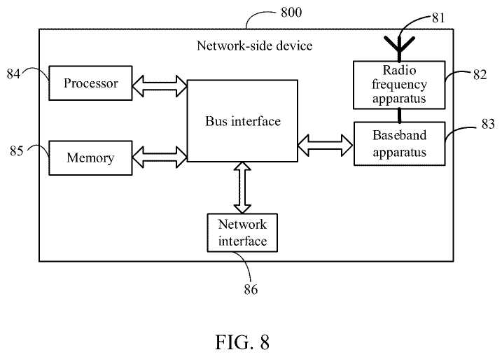

For example, an implementation of this present disclosure further provides a network-side device. As shown in FIG. 8, the network-side device 800 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes to-be-sent information, and sends the information to the radio frequency apparatus 82; and the radio frequency apparatus 82 processes the received information and then sends the information out by using the antenna 81.

The method performed by the network-side device in the foregoing implementation may be implemented in the baseband apparatus 83. The baseband apparatus 83 includes a baseband processor.

The baseband apparatus 83 may include, for example, at least one baseband unit, where a plurality of chips are disposed on the baseband unit. As shown in FIG. 8, one of the chips is, for example, the baseband processor, connected to the memory 85 by using a bus interface, to invoke a program in the memory 85 to perform the operation of the network device shown in the foregoing method implementation.

The network-side device may further include a network interface 86, where the interface is, for example, a Common Public Radio Interface (CPRI).

For example, the network-side device 800 in this implementation of this present disclosure further includes a program or instructions stored in the memory 85 and capable of running on the processor 84. When the processor 84 invokes the program or instructions in the memory 85, the method performed by each module shown in FIG. 5 is performed, with the same technical effect achieved. To avoid repetition, details are not described herein again.

An implementation of this present disclosure further provides a readable storage medium. The readable storage medium stores a program or instructions. When the program or instructions are executed by a processor, each process of the foregoing transmission processing method implementation is implemented, with the same technical effect achieved. To avoid repetition, details are not described herein again.

The processor is a processor in the terminal in the foregoing implementation. The readable storage medium includes a computer-readable storage medium, such as a computer read-only memory ROM, a random access memory RAM, a magnetic disk, or an optical disc.

In addition, an implementation of this present disclosure provides a chip. The chip includes a processor and a communication interface. The communication interface is coupled to the processor. The processor is configured to run a program or instructions to implement each process of the foregoing transmission processing method implementation, with the same technical effect achieved. To avoid repetition, details are not described herein again.

It should be understood that the chip provided in this implementation of this present disclosure may also be referred to as a system-level chip, a system chip, a chip system, a system-on-chip, or the like.

In addition, an implementation of this present disclosure provides a computer program or program product. The computer program or program product is stored in a storage medium. The computer program or program product is executed by at least one processor to implement each process of the foregoing transmission processing method implementation, with the same technical effect achieved. To avoid repetition, details are not described herein again.

An implementation of this present disclosure further provides a communication system, including a terminal and a network-side device. The terminal may be configured to perform the steps of the foregoing transmission processing method. The network-side device may be configured to perform the steps of the foregoing transmission processing method.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this present disclosure is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing implementations may be implemented by using software in combination with a necessary general hardware platform, or may be implemented by using hardware. However, in most cases, the former is a preferred implementation. Based on such an understanding, the technical solutions of this present disclosure essentially or the part contributing to the related art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the implementations of this present disclosure.

The foregoing describes the implementations of this present disclosure with reference to the accompanying drawings. However, this present disclosure is not limited to the foregoing specific implementations. The foregoing specific implementations are merely illustrative rather than restrictive. Inspired by this present disclosure, a person of ordinary skill in the art may develop many other manners without departing from principles of this present disclosure and the protection scope of the claims, and all such manners fall within the protection scope of this present disclosure.

What is claimed is:

1. A transmission processing method, comprising:
obtaining, by a terminal, control information; and
performing, based on the control information, a target transmission corresponding to the control information, wherein the control information or the target transmission corresponding to the control information meets a scheduling restriction; wherein
the control information corresponds to transmissions on at least two cells.

2. The method according to claim 1, wherein the target transmission comprises at least one of the following:
at least part of one or more transmissions on at least one of the at least two cells corresponding to the control information;
at least one of the at least two transmissions corresponding to the control information;
at least part of one or more transmissions on a first cell, wherein the first cell is a cell with a Subcarrier Spacing (SCS) less than or equal to a first reference SCS in the at least two cells corresponding to the control information;
a first transmission, wherein the first transmission is at least part of one or more transmissions with SCSs less than or equal to the first reference SCS in the at least two transmissions corresponding to the control information;
at least part of one or more transmissions on a second cell, wherein the second cell is an cell with a subcarrier spacing SCS greater than or equal to a second reference SCS in the at least two cells corresponding to the control information;
a second transmission, wherein the second transmission is at least part of one or more transmissions with SCSs greater than or equal to the second reference SCS in the at least two transmissions corresponding to the control information;
at least part of one or more transmissions on a third cell, wherein the third cell comprises at least one of an cell not configured with a Transmission Configuration Indicator (TCI) or multiple beams or a Quasi-Co-Location (QCL) source, an cell without an activated TCI or multiple activated beams or an activated QCL source, an cell on which a TCI or multiple beams or a QCL source is activated but does not take effect, an cell within a frequency range FR1, or an cell not higher than a first preset frequency domain position;
a third transmission, wherein the third transmission comprises at least part of: a transmission not configured with a transmission configuration indicator TCI or multiple beams or a quasi-co-location QCL source, a transmission without an activated TCI or multiple activated beams or an activated QCL source, a transmission in which a TCI or multiple beams or a QCL source is activated but does not take effect, a transmission within the frequency range FR1, or a transmission not higher than the first preset frequency domain position;
at least part of one or more transmissions on a fourth cell, wherein the fourth cell comprises at least one of an cell configured with a TCI or multiple beams or a QCL source, an cell with an activated TCI or multiple activated beams or an activated QCL source, an cell on which a TCI or multiple beams or a QCL source is activated and takes effect, an cell within a frequency range FR2, or an cell not lower than a second preset frequency domain position; or
a fourth transmission, wherein the fourth transmission comprises at least part of: a transmission configured with a TCI or multiple beams or a QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

3. The method according to claim 1, wherein meeting the scheduling restriction comprises at least one of the following:
an interval between a first position corresponding to the control information and a second position corresponding to the target transmission is greater than or equal to first duration;
the second position corresponding to the target transmission is not earlier than a first target position; or
the first position corresponding to the control information is not later than a second target position,
wherein the first target position is related to the first position and the first duration; the first target position is:
a time position after the first duration from the first position; or
an available time position after the first duration from the first position.

4. The method according to claim 1, further comprising at least one of the following:
determining, by the terminal, the QCL source or a beam switching time in a corresponding manner based on whether an interval between a first position corresponding to the control information and a second position corresponding to the target transmission is greater than or equal to first duration;
determining, by the terminal, the QCL source or the beam switching time in a corresponding manner based on whether the second position is not earlier than a first target position; or
determining, by the terminal, the QCL source or the beam switching time in a corresponding manner based on whether the first position is not later than a second target position,
wherein the second target position is related to the second position and the first duration, the second target position is:
a time position that is before the second position and is the first duration away from the second position; or
an available time position that is before the second position and is the first duration away from the second position.

5. The method according to claim 2, wherein the scheduling restriction is related to first information, and the first information comprises at least one of the following:
an SCS of the control information;
a time domain start point of the control information; or
a scheduling offset.

6. The method according to claim 5, wherein at least one of a first duration, the first target position, or the second target position is related to the first information.

7. The method according to claim 5, wherein the first information further comprises a target SCS, the target SCS comprises at least one of the following:
a first specific SCS, wherein the first specific SCS is at least part of one or more SCSs of the at least two cells corresponding to the control information or at least part of one or more SCSs of the at least two transmissions corresponding to the control information;
a second specific SCS, wherein the second specific SCS is at least part of one or more SCSs of the first cell or at least part of one or more SCSs of the first transmission;
a third specific SCS, wherein the third specific SCS is at least part of one or more SCSs of the second cell or at least part of one or more SCSs of the second transmission;
a fourth specific SCS, wherein the fourth specific SCS is at least part of one or more SCSs of the third cell or at least part of one or more SCSs of the third transmission; or
a fifth specific SCS, wherein the fifth specific SCS is at least part of one or more SCSs of the fourth cell or at least part of one or more SCSs of the fourth transmission.

8. The method according to claim 5, wherein the first information further comprises time domain duration of a reference transmission or a third position corresponding to the reference transmission, the reference transmission comprises at least one of the following:
at least part of one or more transmissions on at least one of the at least two cells corresponding to the control information;
at least one of the at least two transmissions corresponding to the control information;
at least part of one or more transmissions on a first cell, wherein the first cell is an cell with a subcarrier spacing SCS less than or equal to the first reference SCS in the at least two cells corresponding to the control information;
a first transmission, wherein the first transmission is at least part of one or more transmissions with SCSs less than or equal to the first reference SCS in the at least two transmissions corresponding to the control information;
at least part of one or more transmissions on a second cell, wherein the second cell is an cell with a subcarrier spacing SCS greater than or equal to the second reference SCS in the at least two cells corresponding to the control information;
a second transmission, wherein the second transmission is at least part of one or more transmissions with SCSs greater than or equal to the second reference SCS in the at least two transmissions corresponding to the control information;
at least part of one or more transmissions on a third cell, wherein the third cell comprises at least one of an cell not configured with a transmission configuration indicator TCI or multiple beams or a quasi-co-location QCL source, an cell without an activated TCI or multiple activated beams or an activated QCL source, an cell on which a TCI or multiple beams or a QCL source is activated but does not take effect, an cell within the frequency range FR1, or an cell not higher than the first preset frequency domain position;
a third transmission, wherein the third transmission comprises at least part of: a transmission not configured with a transmission configuration indicator TCI or multiple beams or a quasi-co-location QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position;
at least part of one or more transmissions on a fourth cell, wherein the fourth cell comprises at least one of an cell configured with a TCI or multiple beams or a quasi-co-location QCL source, an cell with an activated TCI or multiple activated beams or an activated QCL source, an cell on which a TCI or multiple beams or a QCL source is activated and takes effect, an cell within the frequency range FR2, or an cell not lower than the second preset frequency domain position; or
a fourth transmission, wherein the fourth transmission comprises at least part of: a transmission configured with a TCI or multiple beams or a quasi-co-location QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

9. The method according to claim 2, wherein the first transmission is at least one of the following:
all the transmissions with SCSs less than or equal to the first reference SCS in the at least two transmissions corresponding to the control information;
a transmission with an SCS less than or equal to the first reference SCS and with an earliest start position in the at least two transmissions corresponding to the control information;
a transmission with an SCS less than or equal to the first reference SCS and with a latest start position in the at least two transmissions corresponding to the control information;
a transmission with an SCS less than or equal to the first reference SCS and with an earliest end position in the at least two transmissions corresponding to the control information; or
a transmission with an SCS less than or equal to the first reference SCS and with a latest end position in the at least two transmissions corresponding to the control information,
or
wherein the second transmission is at least one of the following:
all the transmissions with SCSs greater than or equal to the second reference SCS in the at least two transmissions corresponding to the control information;
a transmission with an SCS greater than or equal to the second reference SCS and with an earliest start position in the at least two transmissions corresponding to the control information;
a transmission with an SCS greater than or equal to the second reference SCS and with a latest start position in the at least two transmissions corresponding to the control information;
a transmission with an SCS greater than or equal to the second reference SCS and with an earliest end position in the at least two transmissions corresponding to the control information; or
a transmission with an SCS greater than or equal to the second reference SCS and with a latest end position in the at least two transmissions corresponding to the control information, or
wherein the at least part of the one or more transmissions on the first cell comprise at least one of the following:
all the transmissions on the first cell;
a transmission with an earliest start position in all the transmissions on the first cell;
a transmission with a latest start position in all the transmissions on the first cell;
a transmission with an earliest end position in all the transmissions on the first cell; or
a transmission with a latest end position in all the transmissions on the first cell,
or
wherein the at least part of the one or more transmissions on the second cell comprise at least one of the following:
all the transmissions on the second cell;
a transmission with an earliest start position in all the transmissions on the second cell;
a transmission with a latest start position in all the transmissions on the second cell;
a transmission with an earliest end position in all the transmissions on the second cell; or
a transmission with a latest end position in all the transmissions on the second cell.

10. The method according to claim 3, wherein the first duration is related to second information, and the second information comprises at least one of the following:
a scheduling offset;
a scheduling interval;
a second time required for beam switching; or
a third time required for QCL.

11. The method according to claim 5, wherein the second time required for beam switching comprises a beam switching time and a beam switching extra time; or
the first information further comprises a third time required for QCL, the third time required for QCL comprises a time required for QCL, or a time required for QCL and an extra time required for QCL,
or
wherein the first information further comprises a scheduling interval, the scheduling interval comprises at least one of the following:
a first specific scheduling interval for cross-slot scheduling;
a second specific scheduling interval in scheduling intervals corresponding to the control information;
a third specific scheduling interval in scheduling intervals corresponding to the first cell;
a fourth specific scheduling interval in scheduling intervals corresponding to the first transmission;
a fifth specific scheduling interval in scheduling intervals corresponding to the second cell; or
a sixth specific scheduling interval in scheduling intervals corresponding to the second transmission.
or
wherein the scheduling offset comprises at least one of the following:
a first specific scheduling offset;
a second specific scheduling offset in scheduling offsets corresponding to the control information;
a third specific scheduling offset in scheduling offsets corresponding to the first cell;
a fourth specific scheduling offset in scheduling offsets corresponding to the first transmission;
a fifth specific scheduling offset in scheduling offsets corresponding to the second cell;
or
a sixth specific scheduling offset in scheduling offsets corresponding to the second transmission.

12. The method according to claim 7, wherein the scheduling restriction is at least related to the first specific SCS when the target transmission is the at least part of the one or more transmissions on the at least one cell corresponding to the control information or the at least one transmission corresponding to the control information;
or
the scheduling restriction is at least related to the second specific SCS when the target transmission is the at least part of the one or more transmissions on the first cell or when the target transmission is the first transmission;
or
the scheduling restriction is at least related to the third specific SCS when the target transmission is the at least part of the one or more transmissions on the second cell or when the target transmission is the second transmission;
or
the scheduling restriction is at least related to at least one of the first specific SCS, the fourth specific SCS, the fifth specific SCS, or the frequency domain position when the target transmission is the at least part of the one or more transmissions on the third cell or when the target transmission is the third transmission;
or
the scheduling restriction is at least related to at least one of the first specific SCS, the fourth specific SCS, the fifth specific SCS, or the frequency domain position when the target transmission is the at least part of the one or more transmissions on the fourth cell or when the target transmission is the fourth transmission.

13. A transmission processing method, comprising:
sending, by a network-side device, control information, wherein the control information or a target transmission corresponding to the control information meets a scheduling restriction,
wherein the control information corresponds to transmissions on at least two cells, or the control information corresponds to at least two transmissions.

14. The method according to claim 13, wherein the target transmission comprises at least one of the following:
at least part of one or more transmissions on at least one of the at least two cells corresponding to the control information;
at least one of the at least two transmissions corresponding to the control information;
at least part of one or more transmissions on a first cell, wherein the first cell is an cell with a subcarrier spacing SCS less than or equal to a first reference SCS in the at least two cells corresponding to the control information;
a first transmission, wherein the first transmission is at least part of one or more transmissions with SCSs less than or equal to the first reference SCS in the at least two transmissions corresponding to the control information;
at least part of one or more transmissions on a second cell, wherein the second cell is an cell with a subcarrier spacing SCS greater than or equal to a second reference SCS in the at least two cells corresponding to the control information;
a second transmission, wherein the second transmission is at least part of one or more transmissions with SCSs greater than or equal to the second reference SCS in the at least two transmissions corresponding to the control information;
at least part of one or more transmissions on a third cell, wherein the third cell comprises at least one of an cell not configured with a transmission configuration indicator TCI or multiple beams or a quasi-co-location QCL source, an cell without an activated TCI or multiple activated beams or an activated QCL source, an cell on which a TCI or multiple beams or a QCL source is activated but does not take effect, an cell within a frequency range FR1, or an cell not higher than a first preset frequency domain position;
a third transmission, wherein the third transmission comprises at least part of: a transmission not configured with a transmission configuration indicator TCI or multiple beams or a quasi-co-location QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position;
at least part of one or more transmissions on a fourth cell, wherein the fourth cell comprises at least one of an cell configured with a TCI or multiple beams or a quasi-co-location QCL source, an cell with an activated TCI or multiple activated beams or an activated QCL source, an cell on which a TCI or multiple beams or a QCL source is activated and takes effect, an cell within a frequency range FR2, or an cell not lower than a second preset frequency domain position; or
a fourth transmission, wherein the fourth transmission comprises at least part of: a transmission configured with a TCI or multiple beams or a quasi-co-location QCL source, a transmission with an activated TCI or multiple activated beams or an activated QCL source, a transmission in which a TCI or multiple beams or a QCL source is activated and takes effect, a transmission within the frequency range FR2, or a transmission not lower than the second preset frequency domain position.

15. The method according to claim 14, wherein the scheduling restriction is related to first information, and the first information comprises at least one of the following:
an SCS of the control information;
a time domain start point of the control information; or
a scheduling offset.

16. The method according to claim 15, wherein at least one of a first duration, the first target position, or the second target position is related to the first information.

17. The method according to claim 15, wherein the first information further comprises a target SCS, the target SCS comprises at least one of the following:
a first specific SCS, wherein the first specific SCS is at least part of one or more SCSs of the at least two cells corresponding to the control information or at least part of one or more SCSs of the at least two transmissions corresponding to the control information;
a second specific SCS, wherein the second specific SCS is at least part of one or more SCSs of the first cell or at least part of one or more SCSs of the first transmission;
a third specific SCS, wherein the third specific SCS is at least part of one or more SCSs of the second cell or at least part of one or more SCSs of the second transmission;
a fourth specific SCS, wherein the fourth specific SCS is at least part of one or more SCSs of the third cell or at least part of one or more SCSs of the third transmission; and
a fifth specific SCS, wherein the fifth specific SCS is at least part of one or more SCSs of the fourth cell or at least part of one or more SCSs of the fourth transmission.

18. The method according to claim 15, wherein the first information further comprises time domain duration of a reference transmission or a third position corresponding to the reference transmission, the reference transmission comprises at least one of the following:
at least part of one or more transmissions on at least one of the at least two cells corresponding to the control information;
at least one of the at least two transmissions corresponding to the control information;
at least part of one or more transmissions on a first cell, wherein the first cell is an cell with a subcarrier spacing SCS less than or equal to the first reference SCS in the at least two cells corresponding to the control information;
a first transmission, wherein the first transmission is at least part of one or more transmissions with SCSs less than or equal to the first reference SCS in the at least two transmissions corresponding to the control information;
at least part of one or more transmissions on a second cell, wherein the second cell is an cell with a subcarrier spacing SCS greater than or equal to the second reference SCS in the at least two cells corresponding to the control information;
a second transmission, wherein the second transmission is at least part of one or more transmissions with SCSs greater than or equal to the second reference SCS in the at least two transmissions corresponding to the control information;
at least part of one or more transmissions on a third cell, wherein the third cell comprises at least one of an cell not configured with a transmission configuration indicator TCI or multiple beams or a quasi-co-location QCL source, an cell without an activated TCI or multiple activated beams or an activated QCL source, an cell on which a TCI or multiple beams or a QCL source is activated but does not take effect, an cell within the frequency range FR1, and an cell not higher than the first preset frequency domain position;
a third transmission, wherein the third transmission comprises at least part of: a transmission not configured with a transmission configuration indicator TCI or multiple beams or a quasi-co-location QCL source, a transmission without an activated TCI or multiple activated beams or an activated QCL source, a transmission in which a TCI or multiple beams or a QCL source is activated but does not take effect, a transmission within the frequency range FR1, and a transmission not higher than the first preset frequency domain position;
at least part of one or more transmissions on a fourth cell, wherein the fourth cell comprises at least one of an cell configured with a TCI or multiple beams or a quasi-co-location QCL source, an cell with an activated TCI or multiple activated beams or an activated QCL source, an cell on which a TCI or multiple beams or a QCL source is activated and takes effect, an cell within the frequency range FR2, and an cell not lower than the second preset frequency domain position; and
a fourth transmission, wherein the fourth transmission comprises at least part of: a transmission configured with a TCI or multiple beams or a quasi-co-location QCL source, a transmission with an activated TCI or multiple activated beams or an activated QCL source, a transmission in which a TCI or multiple beams or a QCL source is activated and takes effect, a transmission within the frequency range FR2, and a transmission not lower than the second preset frequency domain position.

19. The method according to claim 15, wherein the second time required for beam switching comprises a beam switching time and a beam switching extra time; or
the first information further comprises a third time required for QCL, the third time required for QCL comprises a time required for QCL, or a time required for QCL and an extra time required for QCL,
or
wherein the first information further comprises a scheduling interval, the scheduling interval comprises at least one of the following:
a first specific scheduling interval for cross-slot scheduling;
a second specific scheduling interval in scheduling intervals corresponding to the control information;
a third specific scheduling interval in scheduling intervals corresponding to the first cell;
a fourth specific scheduling interval in scheduling intervals corresponding to the first transmission;
a fifth specific scheduling interval in scheduling intervals corresponding to the second cell; and
a sixth specific scheduling interval in scheduling intervals corresponding to the second transmission,
or
wherein the scheduling offset comprises at least one of the following:
a first specific scheduling offset;
a second specific scheduling offset in scheduling offsets corresponding to the control information;
a third specific scheduling offset in scheduling offsets corresponding to the first cell;
a fourth specific scheduling offset in scheduling offsets corresponding to the first transmission;
a fifth specific scheduling offset in scheduling offsets corresponding to the second cell; or
a sixth specific scheduling offset in scheduling offsets corresponding to the second transmission.

20. A terminal, comprising a processor and a memory storing instructions, wherein the instructions, when executed by the processor, cause the processor to perform operations comprising:
obtaining control information; and
performing a corresponding terminal behavior based on the control information,
wherein performing the corresponding terminal behavior based on the control information comprises at least one of the following:
performing, based on the control information, a target transmission corresponding to the control information, wherein the control information or the target transmission corresponding to the control information meets a scheduling restriction;
performing, based on the control information, at least a first part of one or more transmissions corresponding to the control information; or
skipping or discarding, based on the control information, at least a second part of the one or more transmissions corresponding to the control information, wherein
the control information corresponds to transmissions on at least two cells, or the control information corresponds to at least two transmissions.
